(19) United States
(12) Patent Application Publication
(10) Pub. No.: US 2013/0211975 A1
(43) Pub. Date: Aug. 15, 2013

(54) PORTABLE ELECTRONIC KIT FOR PAYROLL VOUCHER, TIME TRACKING, AND PRODUCTION ADMINISTRATION IN THE ENTERTAINMENT INDUSTRY

(71) Applicants: Kevin James Masterson, Fort Lauderdale, FL (US); Luke Dennis Pearsall, Spring Lake Heights, NJ (US)

(72) Inventors: Kevin James Masterson, Fort Lauderdale, FL (US); Luke Dennis Pearsall, Spring Lake Heights, NJ (US)

(21) Appl. No.: 13/685,679

(22) Filed: Nov. 26, 2012

Related U.S. Application Data
(60) Provisional application No. 61/563,760, filed on Nov. 26, 2011.

(51) Int. Cl. G06Q 40/00

(52) U.S. Cl. CPC G06Q 40/105
USPC 705/28; 705/32

(57) ABSTRACT

The invention discloses a portable luggage-sized kit and integrated hardware-software system for streamlined digital administration of production projects in the entertainment industry, said kit comprising a suite of electronic devices and a GUI-driven interface specially adapted for the unique demands of payroll, time and attendance monitoring, prop and wardrobe inventory, and administrative management of projects according to customizable settings for compliance with relevant guild, union, and project-specific rules. The kit includes handheld scanners, card and tag readers, badge and voucher printers, database architecture, web services, fillable forms and intelligent menu navigation that share data in real time across a network linking an expandable range of nodes in horizontal and vertical hierarchies of project roles. The system electronically processes payroll vouchers, check-in and check-out events, miscellaneous adjustments and any other personnel data management tasks smoothly and intelligently, saving time, increasing project flexibility, and preventing mistakes.

### CROSS REFERENCE TO RELATED APPLICATIONS

This application claims the benefit of U.S. Provisional Application No. 61/563,760 filed on Nov. 26, 2011.

### BACKGROUND OF THE INVENTION

1. Field of the Invention

The present invention provides integrated hardware and software systems for streamlined administration of the casting, production-management, and payroll functions of the entertainment industry according to the various protocols and customs mandated by actors unions, artisan guilds, and similar genre-specific standard-setting organizations. More specifically, the system of the present invention comprises one or more portable field kits in electronic communication with nodes comprising the various agencies, administrators, and executives responsible for monitoring time and attendance, production day scheduling, payroll voucher processing, inventory tracking, and summary report publication such that data are shared in real-time in easily-exchangeable digital formats across the entire network, from the crews on-set to the office personnel in their respective company locations.

2. Description of the Related Art

No admission is made that any reference, including any patent or patent document, cited in this specification constitutes prior art applicable to the present invention. Applicant reserves the right to challenge the accuracy and pertinence of any of the documents cited herein. The following review of related art is intended to provide edifying examples of problems and pitfalls in the design and use of time and attendance tracking systems.

All businesses must track the time and attendance of employees and integrate the resulting data with their payroll generating services and project management agendas. Certain businesses such as sales agencies utilize mobile personnel, while other businesses such as construction companies perform work at a variety of temporary and remote job sites. These variables complicate the already difficult tasks of tracking the time and attendance of personnel, of monitoring assets used by personnel, and of performing other related administrative tasks. In the entertainment industry, which comprises film, television, radio, and other performing arts, producers and administrators face a staggering array of obstacles to the effective monitoring of time and attendance. They confront not only the problems recited above for mobile workforces with variable and temporary jobsites, but they also confront a regime of industry-specific and union-mandated protocols that govern employee rights, duties, compensation, work schedules, and performance activities.

Time and attendance keeping systems traditionally involve the activation of a device comprising a clock apparatus, an event recording apparatus, and an event signaling means, as described in U.S. Pat. No. 4,506,274 to Coe, issued Mar. 19, 1985, No. 5,459,657 to Wynn et al., issued Oct. 17, 1995, No. 5,550,359 to Bennett, issued Aug. 27, 1996, and No. 5,990,915 to Tenenbaum et al., issued Nov. 23, 1999. The employee or a monitoring administrator can mark the occurrence of an event, such as the employee checking in for a shift or checking out for a break, by operating the event signaling means, which in turn activates the event recording apparatus which in turn references the clock. The event signaling means requires an employee or administrator to perform an action, such as depressing a switch, inserting an ID card or timecard into a slot, or typing a code into a keypad. The event recording apparatus may further comprise an optical scanner or a thermal printer that reads or prints data on a timecard or other recording medium. Thus, the occurrence and identity of an event are logged by an apparatus in response to the behavior of an employee.

Prior time and attendance inventions have accommodated mobile personnel and distributed job sites using systems comprising a central event recording station and distributed event signaling means. These distributed event signaling means may communicate with the central event recorder via landline telephony, cellular signal transmission, internet or other wireless means, as disclosed in references including U.S. Pat. No. 6,802,005 to Berson, issued Oct. 5, 2004, U.S. Pat. No. 7,114,648 to Ginskey et al., issued Oct. 3, 2006, U.S. Pat. No. 7,367,491 to Cheng et al., issued May 6, 2008, and U.S. Pat. No. 7,835,955 to Brodsky et al., issued Nov. 16, 2010. Distributed event signaling means may comprise dedicated machines, telephones or cellular phones, laptop computers or other personal electronic devices. Such systems are susceptible to fraud because it is often impossible to verify the identity, location, or activity of a person using the event signaling means. Consequently, recent improvements in the art have focused on the addition of biometric scanners, GPS tracking devices, and position-specific automatic sensors to simultaneously record time and attendance data along with location and unique identity data, as disclosed in references including U.S. Pat. App. Pub. No. 20080114683 to Neveu et al., published May 15, 2008, Pub. No. 20070207773 to Braunstein, published Sep. 6, 2007, and Pub. No. 20050021428 to Costello, published Jan. 27, 2005. However, these improvements generate additional problems. They are significantly more expensive and they must be distributed to employees in advance of the job. Employees must be trained to use them, and the devices must be programmed and maintained by a technician of considerable skill. When working with large, fluctuating groups of transient employees or unfamiliar independent contractors, such equipment tends to get stolen or misplaced, further raising costs for the employer.

Work forces typically involved in an entertainment industry project are large and stratified into multiple groups with overlapping duties and schedules. They also comprise a significant number of transient and unfamiliar members; they frequently include stand-ins (“rush calls”) who may be summoned on short notice to replace an absent employee; and they may include “walk-ons” or “extras” recruited on a moment's notice from non-employees present at the job-site or set location. It is impossible to pre-equip impromptu employees with the necessary event-signaling means to use any of the pre-existing systems for time and attendance tracking. It is also important in the entertainment industry for top-level executives and administrators to modify daily schedules at a moment's notice, which existing systems do not effectively allow.

The prevailing methods for keeping time and attendance among actors and crew members on the set of a movie, commercial, or other entertainment production project involve extensive manual recording and processing of data by specially trained administrators. These data include, for example, the names and roles of cast members, the times and circumstances of their checking in and out of set, various ad-hoc bonuses, penalties and designations that must be applied and tracked during production, and industry-specific rules promulgated by guilds and unions according to which the aforementioned data must be correlated. These data and corresponding rules constitute the factors that determine how each individual actor and crew member may be utilized and must be compensated. Such factors must be recorded and processed daily, entered into payroll databases and production summary reports, and transmitted among various groups of people. Resulting data are incorporated into a variety of specialized reports which allow production companies and other managers to monitor budgets, payroll, and performance and to effectively orchestrate the execution of entertainment industry projects. Without precise, detailed scrutiny and oversight, production schedules and budgets will rapidly spiral out of control.

The methods, technologies, and companies currently used to achieve these ends are generally standardized throughout several major subdivisions in the industry from Hollywood to New York City. They are heavily influenced by the directives of the Screen Actors Guild, or SAG. SAG is an American labor union representing over 250,000 film and television principal performers and background performers worldwide. According to SAG's Mission Statement, the Guild seeks, inter alia, to negotiate and enforce collective bargaining agreements that establish equitable levels of compensation, benefits, and working conditions for its performers. As a result, the hiring and casting procedures, time and attendance exceptions, and payroll calculation rules for film and television production projects must be customized, cross-referenced, and periodically updated to adhere to SAG requirements and guidelines. SAG claims exclusive jurisdiction over motion picture performances, and it shares jurisdiction of radio, television, internet, and other new media with a sister union AFTRA, American Federation of Television and Radio Artists. AFTRA performs similar and overlapping functions as SAG, imposing some of its own industry specific requirements upon producers. Internationally, SAG is affiliated with the International Federation of Actors.

Crew and directors' guilds likewise regulate pay and working conditions for their members. The Directors Guild of America (DGA) is an entertainment labor union which represents the interests of film and television directors in the United States motion picture industry. The International Alliance of Theatrical Stage Employees (IATSE) is a labor union representing technicians, artisans and craftspersons in the entertainment industry, including live theatre, motion picture and television production, and trade shows. Failure to agree to abide by these Guild's rules can scuttle a film project, and therefore it is imperative that any time an attendance keeping system covering crew members implement a system to monitor and enforce compliance. For example, many movie studios are contractually precluded from hiring directors who are not signatories to the DGA's compacts. Throughout this specification, the words “guild” and “union” are used interchangeably to refer generally to any and all such labor organizations, unless the text indicates otherwise. The standards and rules as promulgated and published by these various guilds are incorporated by reference herein.

Examples of time and attendance exceptions that pertain to film and television projects due to the influence of SAG and other unions include: restrictions on work hours, minimum rates of pay, rules for work start and stoppage procedures, minimum rest periods, mandatory rest and meal times, mandatory bonuses for specific activities performed by an actor or crew member, restrictions on contractual clauses, special protection requirements for minors and members of vulnerable classes, travel accommodations, wardrobe allowances, stunt pay, monthly limitations on performance time, and a host of other very particular specifications. Without specialized personnel and protocols, it is currently not feasible to manage an entertainment production project while adhering to union rules.

3. Description of the Pre-Existing Methods for Tracking Time and Attendance in the Entertainment Industry

The following explanation illustrates the typical procedure for collecting time and attendance data for an entertainment industry project. Before a day's shoot, a casting company pre-selects relevant data to include in the day's time and attendance records, including the identities of cast and crew members on the shoot (particularly the background actors or “extras”), the times at which they must check in and take breaks and check out, the tasks they MUST perform, they tasks they may or may not perform, and the compensation they each deserve for all of the above. The use of production assets like props and wardrobe may also be tracked. The data so designated are presented in a summary called the “skins report” which is specific for one day or shift on a particular project, or one “production day” in industry jargon.

Simultaneously, a set of “vouchers” is generated. One unique “voucher” is created for each cast member and/or crew member expected on set during the production day. Each voucher typically comprises a carbon-paper form that has been pre-printed with a customized set of data-entry fields specific for each particular employee according to his or her expected roles, duties, and schedule in the project on the given production day. A typical voucher includes the personal identifying information of the employee to whom it relates (e.g., name and address), the name of the project in which he or she is performing, and details regarding pay rates, penalties and bonuses. Vouchers also contain fields labeled, “time in” and “time out,” which are to be marked by the set administrator at the beginning and end of the employee's shift(s). Appropriate data entries and other annotations are handwritten on the vouchers at appropriate times throughout the production day. Vouchers are also commonly updated by the administrator in a designated field or an informal notation called the “miscellaneous adjustment,” which serves as a means for recording unscheduled event data such as last-minute changes in performance duties or schedules, and unexpected penalties or bonuses arising during the production day.

A typical method for using vouchers is as follows. A voucher comprising three carbon copy sheets is given to an employee at the beginning of the production day. The employee is entrusted to record relevant data, including adjustments, throughout the work period. During sign out, the administrator makes additional adjustments and signs the voucher to verify that it contains the correct and complete data. The employee then signs the voucher and takes one carbon copy as his or her receipt. Negligent omissions of data on vouchers prior to check out are quite common. The remaining two carbon copies may be sent to the production offices where they are directed to accounting and payroll departments that use the voucher data to calculate the production day expenses and employee compensation, respectively.

The skins report and vouchers, as first prepared by the casting and/or production company for a given production day, must be delivered to the set before the day's first roll call. Delivery is typically accomplished by a low-level administrator or a third party courier whose performance is not always reliable. Vouchers may be thrown from a delivery vehicle window from the street towards a doorstep or left in a mailbox, exposing them to theft, misplacement, and weather damage. In the entertainment industry, the inconvenient but essential daily task of delivering the skins report and vouchers, on time and without mix-ups, is such a notorious hassle that casting companies often employ night staff whose sole responsibility is delivering the vouchers and skins reports on a nightly basis. Attempts at using email have not perfected the process as human error and misaddressed messages create the same problems in the virtual world as had existed in the material world.

At start time, each employee assigned by the casting department as an extra for the shooting day checks in with the administrator who records data on the voucher and gives a pre-printed, name-personalized carbon copy voucher to the named employee. At the end of the day's shift, each employee checks out and receives a receipt (a carbon copy pulled from the voucher) indicating fulfillment of duties plus any miscellaneous adjustments. Voucher data reflected on the receipt may include any information relevant to the total amount of compensation earned by the employee during the production day, which typically comprise, for example, authorized impromptu work, exposure to certain conditions such as nudity, water, or smoke—these being three examples from a laundry list of conditions that have been specially designated by union rules as triggering automatic bonuses—mishaps in schedule, the employee's obtaining or failing to return wardrobe items and other assets, and the employee's contribution of personal property or pets in the production.

At the end of each day, production, or other time period, the administrator create a “breakdown report” containing an itemized summary of all voucher data. The breakdown report is conceptually similar to the converse of the skins report. To generate a breakdown report, the administrator, plus assistant administrators if the project's budget allows for such additional staff, sorts the vouchers into piles based on characteristics of the data they contain, such as bonuses earned, penalties accrued, base pay rates, or union membership status. The next step is to enter these data into a computerized spreadsheet, hand-written ledger, or other tabulation medium. A copy of the resulting spreadsheet or tabulation may be presented to the production company so they can track performance and costs, identify potential problems, and make changes to procedures as necessary. A copy may be provided to a payroll service to generate pay for the cast and crew members based on their attendance, performance, bonus, penalty and other voucher data or time-card data. In the majority of cases, the production company's production manager receives a copy for his or her approval, which is then sent to the payroll company paymasters for issuance of employee paychecks. Typically, the same company handles casting and payroll, but in other cases multiple copies of the breakdown report must be created and distributed, sometimes in different formats.

Similar procedures pertain to crew members as to actors, with some distinctions. Film crews are divided into a host of departments such as sound, lighting, set design, and other designations according to specialized roles. Each day, an administrator from each department reports time and attendance records for their respective personnel based on a time card, including in time, out time, lunch period, and any pay adjustments a Union crew member may have received according to Union Guidelines. Information is typically hand-written on each daily time card which is submitted at the end of each shooting day to the production company in charge of the entire project. Sent along with these reports are any daily notes which Production may need from that department, i.e., “A light fell and broke today,” or “Crew member x was burned on a lamp and saw the medic and was sent home,” and these data are all recorded and compiled in daily production reports. At the end of a given week, e.g., on Friday, copies of the week's Production Reports are given back to the crew department heads, where the weekly data must be re-entered by hand onto a set of carbon-copy time cards for submission to accounting and/or payroll. Thus, existing methods for monitoring time and attendance of crew members involve tremendous inconvenience and duplication of work.

Additional considerations apply to collecting information about wardrobe and properties (“props”) which are assets may be assigned to the custody and use of various cast and crew members. The prior art process for tracking wardrobe and prop inventory dispositions is inefficient and tedious like the other related time and attendance procedures. Background Actors must wait in line with their respective carbon copy vouchers to speak with a “costumer” who will dress them appropriately for their scene(s). In exchange for the loan of the clothing or prop, the presiding Wardrobe or Props Department administrator will hold the actor's voucher in bail, and will also hand-write on it a description of each item that was loaned to the actor. In cases when multiple or expensive items must be lent to an actor, the actor may be asked to relinquish his or her personal identification, e.g., drivers license, as collateral. This exposes sensitive personal information to potential misappropriation. At the end of the day, the actor will return the Prop or Wardrobe to the appropriate place and recover their collateral, ID, and voucher, which they absolutely need in order to proceed to their daily check-out with the set administrator or other supervising member of Production Personnel.

There are many other pitfalls, problems, and inefficiencies in existing methods. Because check-in, break times, and check-out times are common to large groups of cast and crew members, there is a bottleneck at these times when the administrator has to collect all of their data and handle their vouchers at once. Cast or crew members may be absent on a given day, and a substitute voucher with the same data may need to be created for a rush call or a replacement crew member. A walk-on may be recruited during shooting who needs to be given a voucher and be added to the payroll and data entry system immediately. Transcription and transposition errors are common. Vouchers and breakdown reports are delivered as physical copies which can be lost or delayed during transit. The need for dedicated data entry and administrative assistants on a daily basis to generate vouchers, skins reports, and breakdown reports, and to process the data therein, increase overhead costs of every project.

Such pitfalls, as well as the strong influence of unions upon the production requirements applicable to entertainment projects, combined with the wide range of locations in which performances and shoots can be held, further combined with the need to improve flexibility and efficiency at worksites due to the high costs of production, still further combined with the proliferation of small independent and inexperienced studios/production staffs in recent years which tend to accrue penalties for accidentally or haphazardly violating rules, and other factors have created the need in the marketplace for a simplified, off-the-shelf type of system for managing time and attendance during an entertainment industry project. Consequently, there exists a latent demand for a portable, self-contained kit for use by project administrators in entertainment industry productions which can track time, attendance, pay, and performance measures within the context of union protocols while minimizing paperwork.

### SUMMARY OF THE INVENTION

The present invention satisfies the above needs. It comprises a production management system comprising payroll/attendance, inventory tracking, and/or other regulated administrative operations for the entertainment industry. The system of the present invention is based on a portable self-contained kit that comprises integrated hardware, software, and input/output devices which are specially adapted for compatibility with the demands of the entertainment industry. Among these special adaptations are the inclusion of software and templates which allow administrators to conveniently apply appropriate union and guild protocols and rules as demanded by a particular project. The system and kit are integrated to permit the remote communication between various administrators and managers, the digitization of vouchers and summary reports, the automation and integration of union protocols within time and attendance recording mechanisms, flexible on-site updates and automatic alerts, and real-time information sharing among all parties with a stake or oversight role in a production project. The invention eliminates the need for printing and transporting physical copies of skins reports, breakdown reports, and vouchers. Instead, digital copies of these documents are generated by software included in the invention and transmitted to the appropriate people in the appropriate formats at the appropriate times.

The kit and system are useful for generating payroll and accounting data, and they may also be adapted for tracking props, wardrobes, equipment, and other assets used by the cast and crew involved in a project. Altogether, the combination of hardware and software in the present invention provide unprecedented portability, self-sufficiency, precision, cost-effectiveness, ease of use and flexibility in a time and attendance keeping system for the entertainment industry.

### The ShowBizID Field Kit

Embodiments of the portable kit of the present invention may comprise: a portable container analogous to a suitcase or locker containing various devices and components comprising: a frame fastened to the interior of the portable container to serve as a partitioning means for organizing and securing the hardware component devices of the invention and for insulating them from concussions, moisture, or other hazards; an internally mounted computing device (such as a tablet personal computer; a PC) with a touch-screen user-interface in communication with the system and with the other components of the kit; a keyboard or other means for data entry; an electronic card reader for reading data from magnetic stripes, barcodes, RFID and the like; a docking and charging station for a handheld scanner or a personal digital accessory device (PDA); a corresponding handheld scanner or PDA for data entry at a distance from the kit; a printer or other output means for generating physical copies of information; software for controlling the entry and processing of time and attendance data for entertainment industry productions; a database and software for transferring production data to and from standardized reports and vouchers; a Wi-Fi, cellular, Bluetooth or other means for wirelessly connecting to external communications networks; a power strip mounted inside the container to receive electrical plugs from the components of the invention; a flush mount cord connecter spanning the wall of the portable container to enable connection of the power cord to an external power source while preventing the ingress of water and debris through said wall; and an internally mounted battery.

By incorporating all of the hardware and power source components necessary to operate the time and attendance system into a portable networked kit, the present invention offers a new tool for producers, set administrators, and other entertainment industry professionals to streamline and facilitate time and attendance keeping during projects as well as the adjuvant tasks such as payroll generation, accounting report distribution, and asset management.

The electronic card reader is not exclusively limited to reading cards, but may comprise any device that automatically imports data by scanning a surface wherein data are physically encoded. The power strip distributes electrical power to the component devices of the kit. It may be a prefabricated electrical extension accessory comprising multiple power sockets for receiving AC plugs or it may be a panel-type power board comprising directly wired junctions. In preferred embodiments, the outer casing of the kit is a ruggedized weather-resistant casing having a fastenably closeable cover. Note that the term “PC” does not limit the internal computer component device of the invention to any make, model, chip set, or operating system, but is used generically to refer to any general-use computer.

The time and attendance keeping system of the present invention comprises specialized software, applications, interconnectivity, data processing rules, automatic alert and notification mechanisms, and data collection routines that are specially adapted to comply with the unique demands of the film and entertainment industry. It is a feature of the present invention to eliminate the paperwork and extraneous personnel involved in generating skins reports, vouchers, and breakdown reports characteristic of current methods used in the film industry. The kit and/or components of the kit communicate with one or more internet servers or external electronic devices to relay information to and from remote parties such as administrators, managers, casting companies, payroll companies, and producers. Time and attendance keeping and related functions are encompassed with the term “personnel data management.”

In addition to reducing the costs and complications associated with entertainment project administration, the present invention facilitates the entry of small, inexperienced, or underfunded production companies into the industry by reducing costs and learning barriers and by facilitating compliance and administration tasks. Its automated data collection and processing functions, wireless transmission capabilities, and integrated compliance and alert functions can help novices avoid costly transgressions of union protocols and eliminate the need for hiring expensive administrative professionals, couriers, and other assistants.

The architecture of the system and software are designed to allow flexible definition of various rule sets and assignment of the production data to particular rule sets. For example, the hardware and system of the invention may be variously programmed to accommodate different rules for different geographical locations within the jurisdiction of one or more Unions. Similarly, adjustments can be made to accommodate rules for non-union actors and artisans. The rule set configured for each particular production project will define how various calculations are applied to the data collected for and generated from that project. These rules are publically available and updated regularly by their respective Unions in various handbooks. The SAG union handbooks are hereby incorporated by reference in their entirety. Any and all other rule disclosures pertaining to actors and crew in entertainment industry projects are hereby incorporated by reference in their entirety, including those of AFTRA, IATSE, and DGA.

At least one embodiment of the present invention is to be marketed under the trade name ShowBizID and ShowBizID Field Kit. At least one application of the ShowBizID system is to be marketed under the trade name “e-Voucher.” The invention may also be presented as SHOWBIZ I.D.

With respect to the some of the distinctive requirements which may apply to monitoring non-actor crew-members, The ShowBizID system allows each Department Head to swipe an individual employee's ID Badge or other identifying card through the card readers of the invention to assign the appropriate time and attendance data into a digital daily time card. Notes and adjustments can be simultaneously entered into the corresponding database record through one of the data entry interfaces such as the touch-screen or keyboard. These digital files and records can then be emailed to the Assistant Director who may upload the constituent data into his or her Production Report. Typically at the end of the week, e.g., on Fridays, the information stored for each crew member will be accessed, data will be updated, and an e-weekly time card will be generated that is then sent to Accounting, and/or Payroll offices for processing. The e-weekly time card (or e-time card) is formatted differently from an e-voucher but generated and manipulated using the same components and processes within the ShowBizID System and Kit. The packaging and delivery of the information is redundant. Each crew member can be emailed a digital copy of the time card for their records replacing the carbon copy method used in the prior art.

The invention also streamlines production asset (i.e., wardrobe and prop) handling without risking the exposure of confidential personal information or the accidental loss of a physical ID, voucher, or other item used as collateral by the borrowing actor or crew member. The ShowBizID system utilizes the same barcode and magnetic strip reading functionality to track these assets as that which it uses to track employees. ShowBizID allows the Wardrobe and Properties departments to inventory their props before a film or television show begins shooting by utilizing any barcode reading method known in the prior art which populates and monitors a designated list of items. In addition to being tagged with barcodes, props and wardrobes may be tagged, or pre-equipped, with RFID tags, magnetic strips, or any other medium for the transmission of identifying information to a computerized scanning device. When a Background Actor is asked to wear clothing or to use a prop from any department, he or she can present a ShowBizID card or unique identifier in conjunction with the act of scanning the barcode or other identifier associated with any tagged item. Thus, the borrowed item can be linked to the actor's digital time and attendance record in the ShowBizID system. Simultaneously or alternatively, a department can track its inventory by linking item records to a particular employee's user ID to identify him or her as having possession of a specific item. This list can be viewed by an administrator at any time, and complete inventory reports can be generated from the ShowBizID databases.

Inventory management issues for production assets like props and wardrobes illustrate a particular advantage of the present invention, in that it comprises more than one scanning apparatus, including at least one portable scanning device (handheld scanner) which can be used remotely from the tablet PC of the ShowBizID Field Kit. The handheld scanner, which is attached to an iPhone, iPod, Personal Digital Accessory, or other portable electronic device, can be used simultaneously with the PC mounted in the container of the ShowBiz ID Field Kit, at any location or distance. Prop and wardrobe tracking can be accomplished concurrently with check-in and check-out, because the prop and wardrobe administrators may use a handheld scanner synchronized with the same Field Kit being used to process e-vouchers by the set administrator. If an employee does not return a borrowed item, the Field Kit may be programmed to refuse their check-out at the end of the day, and may also issue a range of digital alerts, instructions, and reminders via wireless transmission, cellular phone, or email to different persons and departments such as Production, Accounting, and the borrowing employee. Depending on the specificity and range of details programmed into the item-tracking database of the kit, an actor may even be assessed replacement and repair costs when the ShowBizID system notifies payroll that a specific item was lost or damaged by an employee. This versatile and digitized system improves accuracy, information depth, and security of inventory monitoring from the perspective of both employees and administrators. In short, the ShowBizID system can reliably prevent, or “fail-safe,” the occurrence of accidental or intentional theft of props and wardrobes while denying all third parties access to a borrower's confidential personal information.

The forgoing summary has outlined some features consistent with the present invention in order that the following detailed description thereof may be better understood, and in order that the present contribution to the art may be better appreciated. The present invention is not limited in its application, details, or components merely to those set forth in the description and illustrations specifically mentioned herein. Methods and devices consistent with the present invention are capable of other embodiments. Also, the phraseology and terminology employed herein are for the purpose of description and should not be regarded as limiting unless explicitly stated as such. The present invention resides not merely in any one of the features set forth in this specification, but also in the particular combination of all of the features and improvements claimed.

### BRIEF DESCRIPTION OF THE DRAWINGS

FIG. 1 is a top view of a system and kit of the present invention.

FIG. 2 is a top view of a system and kit of the present invention, particularly illustrating the deployment of the fold-out keyboard.

FIG. 3 is a schematic diagram illustrating a system of the present invention.

FIG. 4 is a screen shot of a Graphical User Interface for recording and reporting tasks according to various embodiment of the present invention as described throughout the disclosure, particularly depicting a production management menu.

FIG. 5A is a screen shot of a Graphical User Interface for recording and reporting tasks according to various embodiment of the present invention as described throughout the disclosure depicting a user record and user data fields.

FIG. 5B is a screen shot of a Graphical User Interface for recording and reporting tasks according to various embodiment of the present invention as described throughout the disclosure depicting a user daily report having fields for bonus adjustments.

FIG. 6 is a screen shot of a Graphical User Interface for recording and reporting tasks according to various embodiment of the present invention as described throughout the disclosure displaying a menu option for creating a new user record.

FIG. 7A is a screen shot of a Graphical User Interface for recording and reporting tasks according to various embodiment of the present invention as described throughout the disclosure displaying a menu screen for selecting fillable forms.

FIG. 7B is a screen shot of a Graphical User Interface for recording and reporting tasks according to various embodiment of the present invention as described throughout the disclosure displaying a user-specific terms-of-service agreement.

FIG. 8 is a screen shot of a Graphical User Interface for recording and reporting tasks according to various embodiment of the present invention as described throughout the disclosure depicting a screen for accessing the data in an individual user's record.

FIG. 9 is a screen shot of a Graphical User Interface for recording and reporting tasks according to various embodiment of the present invention as described throughout the disclosure depicting options for assigning project-specific bonuses available to a user's record.

FIG. 10 is a screen shot of a Graphical User Interface for recording and reporting tasks according to various embodiment of the present invention as described throughout the disclosure illustrating a dropdown feature for selecting a range of users for whom performance factor adjustments can be applied.

FIG. 11 is a screen shot of a Graphical User Interface for recording and reporting tasks according to various embodiment of the present invention as described throughout the disclosure depicting a feature for inputting miscellaneous adjustments to a user's record.

FIG. 12 is a screen shot of a Graphical User Interface for recording and reporting tasks according to various embodiment of the present invention as described throughout the disclosure depicting a menu in the Wizard for editing time scans of an individual record.

FIG. 13 is a screen shot of a Graphical User Interface for recording and reporting tasks according to various embodiment of the present invention as described throughout the disclosure displaying a dropdown menu can edit multiple records at once for a selected range of individuals.

FIG. 14 is a screen shot of a Graphical User Interface for recording and reporting tasks according to various embodiment of the present invention as described throughout the disclosure depicting a menu that controls alerts in the Wizard.

FIG. 15 is a screen shot of a Graphical User Interface for recording and reporting tasks according to various embodiment of the present invention as described throughout the disclosure depicting a form that may be used to specify the features of a specific alert.

FIG. 16 is a screen shot of a Graphical User Interface for recording and reporting tasks according to various embodiment of the present invention as described throughout the disclosure depicting a form that may be used to create a new alert using the Wizard.

FIG. 17 is a screen shot of a Graphical User Interface for recording and reporting tasks according to various embodiment of the present invention as described throughout the disclosure depicting a menu button that can access the recall notice configuration application of the Wizard.

FIG. 18 is a screen shot of a Graphical User Interface for recording and reporting tasks according to various embodiment of the present invention as described throughout the disclosure displaying a form for creating an individual recall notice.

FIG. 19 is a screen shot of a Graphical User Interface for recording and reporting tasks according to various embodiment of the present invention as described throughout the disclosure depicting a notification that may appear after a recall instruction or alert has been successfully applied.

FIG. 20 is a screen shot of a Graphical User Interface for recording and reporting tasks according to various embodiment of the present invention as described throughout the disclosure displaying group management options.

FIG. 21 is a screen shot of a Graphical User Interface for recording and reporting tasks according to various embodiment of the present invention as described throughout the disclosure displaying a form for creating a new group using the Wizard.

FIG. 22 is a screen shot of a Graphical User Interface for recording and reporting tasks according to various embodiment of the present invention as described throughout the disclosure showing mechanisms for editing group membership within the Wizard.

FIG. 23 is a screen shot of a Graphical User Interface for recording and reporting tasks according to various embodiment of the present invention as described throughout the disclosure depicting a function for adding users to a group.

FIG. 24 is a screen shot of a Graphical User Interface for recording and reporting tasks according to various embodiment of the present invention as described throughout the disclosure depicting a screen for deleting users from a group.

FIG. 25 is a screen shot of a Graphical User Interface for recording and reporting tasks according to various embodiment of the present invention as described throughout the disclosure depicting a function for assigning bonuses to a group.

FIG. 26 is a screen shot of a Graphical User Interface for recording and reporting tasks according to various embodiment of the present invention as described throughout the disclosure depicting a function for applying miscellaneous adjustments to a group.

FIG. 27 is a screen shot of a Graphical User Interface for recording and reporting tasks according to various embodiment of the present invention as described throughout the disclosure depicting a selection menu for selectively deleting groups.

FIG. 28 is a screen shot of a Graphical User Interface for recording and reporting tasks according to various embodiment of the present invention as described throughout the disclosure illustrating a menu of the Wizard for selecting some of the various reports that may be generated by the present invention.

FIG. 29 is a screen shot of a Graphical User Interface for recording and reporting tasks according to various embodiment of the present invention as described throughout the disclosure depicting a form for creating a Production Report.

FIG. 30 is a screen shot of a Graphical User Interface for recording and reporting tasks according to various embodiment of the present invention as described throughout the disclosure displaying a sample of a user information report.

### DETAILED DESCRIPTION OF THE DRAWINGS

Throughout all the Figures, same or corresponding elements are indicated by the same reference numerals.

### The ShowBizID Field Kit

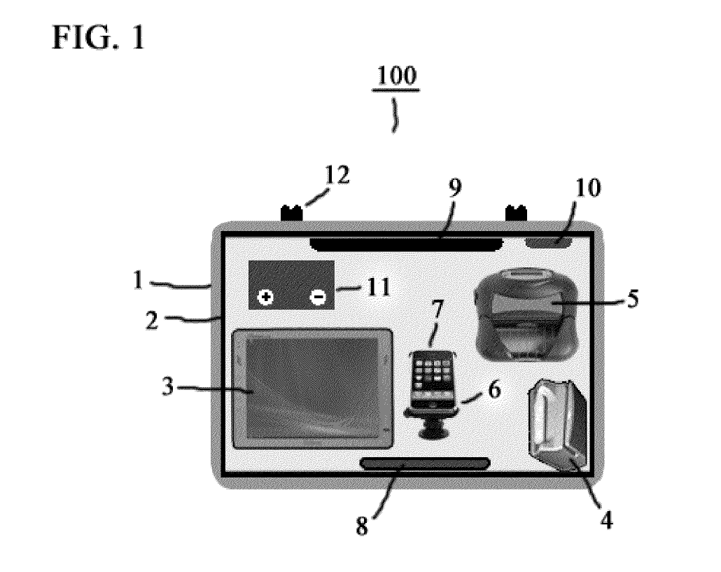

FIG. 1 depicts the ShowBizID Field Kit 100. The Kit 100 generally comprises a portable container 1 resembling a suitcase, briefcase, locker, cabinet, trunk, or other compartment, wherein the functional components of the invention are arranged and stored. An internal frame 2 comprising metal, plastic, rubber, wood, foam or other material suitable for mounting electronic devices may be fastened to the interior of the portable container 1 to organize and hold the various components of the invention and to insulate them from concussions, moisture, and other hazards.

The Kit 100 comprises a personal computing device 3 (PC) providing a user interface such as a video screen and an operating system such as Linux, Microsoft Windows, Android, or Apple OS. In a preferred embodiment, said PC 3 is a tablet PC, such as the Kiosk Siena Slate ruggedized touch screen PC. The PC 3 may incorporate specially adapted software to operate the invention. Said software may be stored within the PC 3 or it may run from a remote server or other remote source. The tablet PC 3 shown in FIG. 1 comprises a touch-screen that responds to fingers and styli. In a preferred embodiment, the PC 3 is configured with the Microsoft Windows operating system, in part because Windows permits the function of auto-populating PDF (Portable Document Format) forms with data from a SQL server database.

The Kit 100 of FIG. 1 further comprises a card reader 4 for reading magnetic strips, RFIDs, barcodes and the like. In a preferred embodiment the card reader 4 is the Eseek Model-250. The card reader 4 can acquire data and personal information from a drivers license, an ID-badge, a custom printed receipt having a barcode, or other compatible media. The Kit 100 also comprises a printer 5. In a preferred embodiment the printer 5 is the Zebra RW420 direct thermal printer having the capability to print receipts with software-specified and/or user-specified barcodes on them. The printer 5 may generate administrative reports, User ID cards, and scannable receipts. Said printer 5 may generate receipts for actors and crew members to take home with them at the end of a production day, or other time interval, as proof of their services rendered. The card reader 4 and/or the printer 5 may communicate directly with the PC 3 and any other components of the Kit 100 such that electrical power and/or data may be exchanged among them. For example, the card reader 4 may transmit information scanned from a person's drivers license to the PC 3 and the PC 3 may send instructions to the printer 5 to generate a custom voucher or receipt bearing text or a barcode. Such interconnectivity may be accomplished by any means for electronic communication including USB cable, Wi-Fi wireless communication, Bluetooth wireless communication, removable thumb drives, firewire cables, and the like.

The Kit 100 of FIG. 1 further comprises a docking and charging station 6 (dock) for a handheld device such as a scanner 7. The handheld scanner 7 may comprise a mobile device in wireless communication with the PC 3 or with other components of the Kit 100. In a preferred embodiment, the handheld scanner 7 is an iPod combined with a Linnea Pro optical barcode scanner and magnetic card reader. In this embodiment, the functionality of the handheld scanner 7 is partially redundant with that of the reader 4. The handheld scanner 7 allows an administrator using the Kit 100 to perform his or her duties at a distance from the container 1 while being able to transmit data wirelessly to and from remote devices. These duties may be, among others, logging time and attendance data, tracking inventory and assets such as props and wardrobe, collecting identification and performance data, and transmitting data to and/or from a remote database or server.

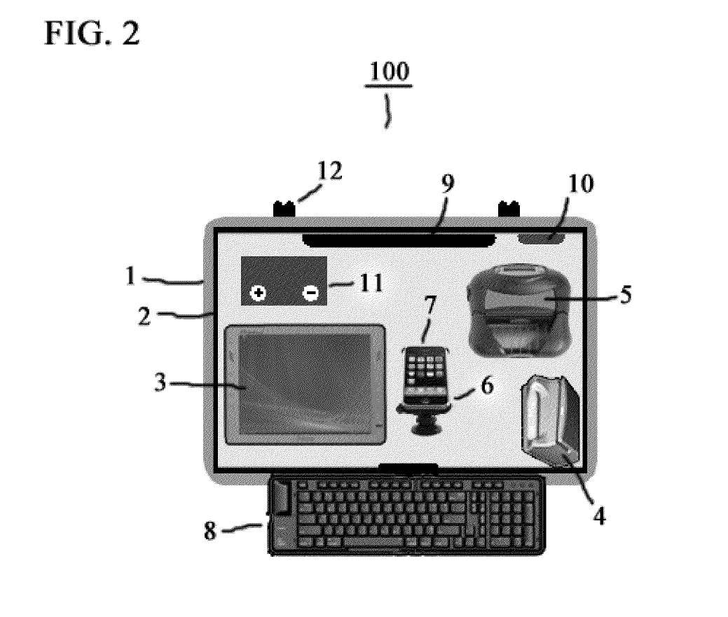

Although embodiments of the Kit 100 comprise a PC 3 having a touch-sensitive screen permitting entry of data into the PC 3 and into the system of the present invention, embodiments may also comprise a keyboard or keypad 8 in communication with the PC 3. Said keypad 8 may be a standard keyboard or a folding apparatus. FIG. 2 depicts the Kit 100 in which the keyboard 8 is a folding keyboard in an unfurled configuration. When not in use, said keyboard 8 may be securely and conveniently stowed inside the container 1.

In preferred embodiments, a purpose of the Kit 100 is to permit the processing of time, attendance, and performance data of personnel in remote, impromptu, and/or outdoor locations. Therefore, the Kit 100 is equipped with one or more power supply options. A power strip 9 mounted inside the container 1 may receive plugs or electrical cords from the various components of the Kit 100, such as the PC 3 and/or the dock 6 and/or the printer 5. Said power strip 9 may be connected to a flush mount cord connector 10 spanning the wall of the container 1 such that a water-resistant junction to an external power source exists. The cord connector 10 may be ruggedized to prevent passage of water, debris, or other matter from the external to internal environment of the Kit 100. One or more of a battery 11 may also be included within the container 1 as an independent or redundant source of power. The Kit 100 may further comprise a local SQL server, for example a SQL server in the PC 3, where data relevant to time, attendance, performance, and the disposition of assets may be stored.

The container 1 of the Kit 100 may be closed, sealed, and/or locked to protect the internal components from external hazards and/or to prevent tampering by unauthorized parties. In a preferred embodiment this function is achieved by closing a lid or cover attached via hinges 12.

### The ShowBizID Networked System

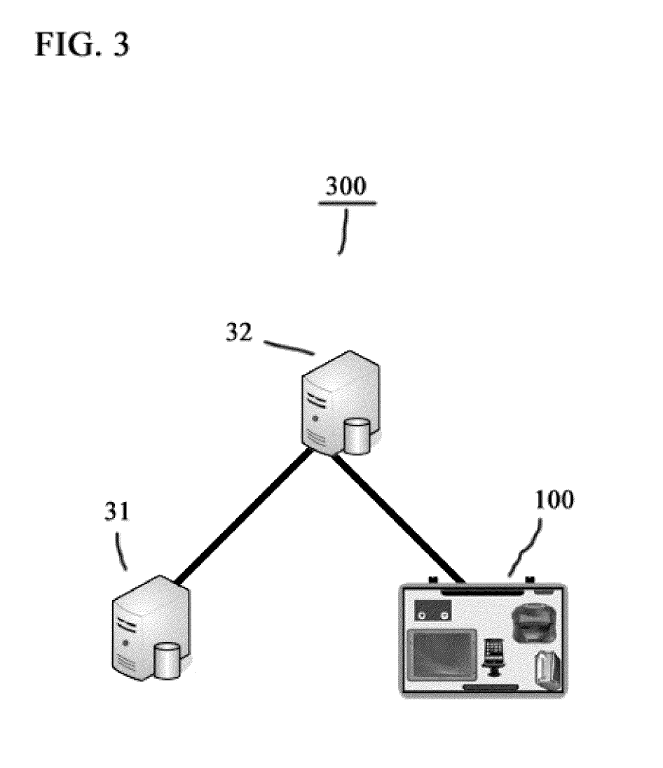

FIG. 3 illustrates the Kit 100 as part of a System 300 for processing time, attendance, and performance data during a project. The system may also be used to monitor and control multiple production projects or job sites simultaneously. A third party server 31 is accessible by producers, casting companies, payroll companies and other participants of an entertainment production project. A central server 32 is controlled by the owner, vendor, and/or user of the ShowBizID System 300 and/or one or more ShowBizID Field Kits 100. The servers 31 and 32 are in communication with each other via any known technologies and protocols, and in particular via secure Web Services. A casting company may upload “skins” data or a “skins report” from a third party server 31 to a database in the central server 32 through secure web services. A payroll company may request and download e-vouchers or data relevant to time, attendance, and performance of cast and crew in a production project from a central server 32. Data downloaded from a central server 32 may be stored in a database on a third party server 31 for future retrieval, processing, or distribution. A central server 32 may process and store “skins” data and voucher data, and it may do so via a SQL database and an IIS Web Server.

A central server 32 may communicate with one or more Field Kits 100, preferably via secure web services. Field Kits 100 may remotely receive data from a central server 32, such as data that indicate the expected time, attendance, and performance metrics for a particular project and date. In industry terms, such data is commonly referred to as “skins data” data which may pertain to a particular “shooting day” or “production day.” A central server 32 may answer requests for data to and/or from a Field Kit 100 and may store or process data for distribution to the same or a different Field Kit 100. A Field Kit 100 may remain in constant communication with a central server 32 throughout a production day, or other interval of time, or a Field Kit 100 may operate offline until the end or closing of the production day, or other interval or time. At the desired time(s), collected data are uploaded from the kit(s) 100 to the central server 32. Production company employees or other production site administrators may collect data throughout the day using the tablet PC 3, mobile handheld scanner 7, or other devices in a Field Kit 100. Typically, the tablet PC 3 and/or handheld device 7 of the Field Kit 100 communicate with the ShowBizID central server 32 via Web Services, but any communication means for transferring data among distributed computers may be utilized.

The hardware depicted in FIG. 3 may include software components specially adapted for use with the ShowBizID System 300 and Kit 100.

### Methods of Operation

The invention can be applied to track the time and attendance of employees during an entertainment industry project as follows. In preparation for a production day, a casting company transmits data comprising the skins report and voucher data to a database on a central server 32 via the internet or other means for transmitting data. Unlike the prior art skins report and voucher data, the ShowBizID version includes a unique user ID assigned to each employee to rapidly identify the respective employee without risking the exposure of sensitive personal information. The ShowBizID skins report and voucher data may also associate photographs, biometric data, or any other relevant documents and data, with each employee record since the costs of transmitting data digitally is negligible compared to the prior art custom of printing and hand-delivering reports and vouchers. The term “electronic voucher process” is defined here as encompassing all aspects of time and attendance keeping involving the preparation, use, and disposition of electronic vouchers, and these are considered administrative tasks related to “personnel data management.”

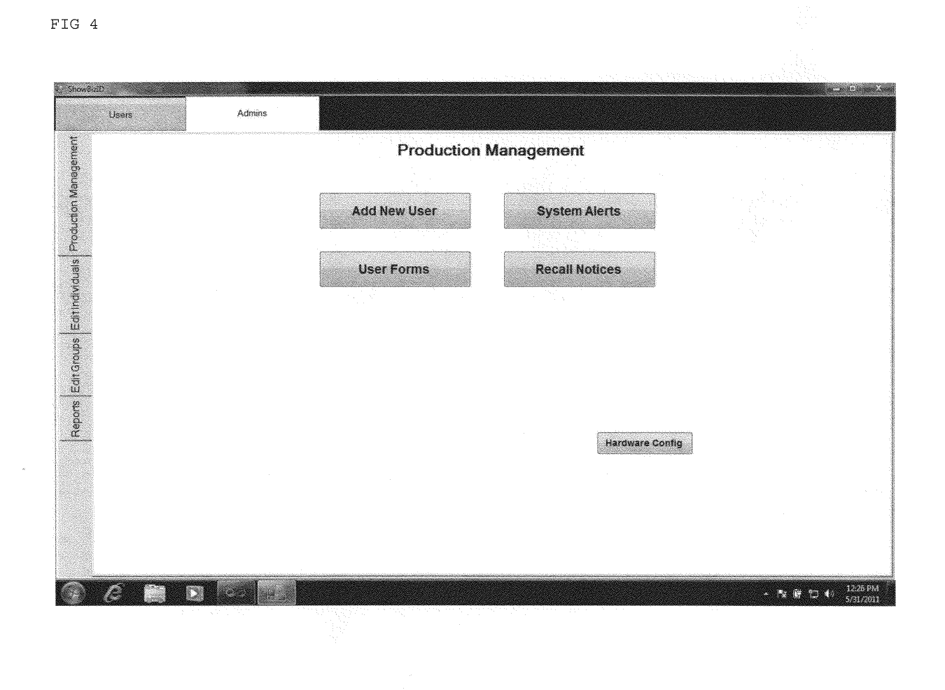

On location, an administrator operates a ShowBizID Field Kit 100. Before the start of the production day, the administrator opens the container covering the kit and he or she may select a desired power source from among the internal battery or the external power cord, which in turn may draw power from a car battery, an electrical generator, or a standard AC outlet or other fixture at the set location. The administrator activates the kit by powering on the components, which in a preferred embodiment is accomplished by one master power switch. When the PC is powered on, a dedicated software program comprising a graphical user interface (GUI) may be executed. In a preferred embodiment the PC opens a wizard program (ShowBizID Wizard, or Wizard) that guides the administrator through the time and attendance functions of the invention. A first prompt on the touch screen of the PC may request the administrator to input or select a production project by name, date, or other criteria. Upon specification of the desired production project, the appropriate production data are accessed by the Wizard. Production data comprise a list of actors, employees, and/or users relevant to a production project, and/or a skins report specific to a production day, and/or a set of electronic vouchers (e-Vouchers) corresponding to cast and crew members. These data and the configuration of the hardware and software may be modified by an administrator using the GUI, and a sample screen shot showing one method of accessing the relevant function within the Wizard is shown in FIG. 4.

The PC 3 establishes a connection to the internet. The PC 3 may access the central server 32 containing a database in which a skins report and/or e-Vouchers are stored that may be downloaded to an appropriately configured database on the PC 3 via secure web services. Alternatively, the skins report and/or e-Vouchers may be uploaded to the PC 3 from a separate device such as a flash drive or bluetooth-enabled personal computing device. The database on the PC 3 is pre-configured to receive the skins report and e-Vouchers, or it may be modified by the administrator to customize the organization of the data.

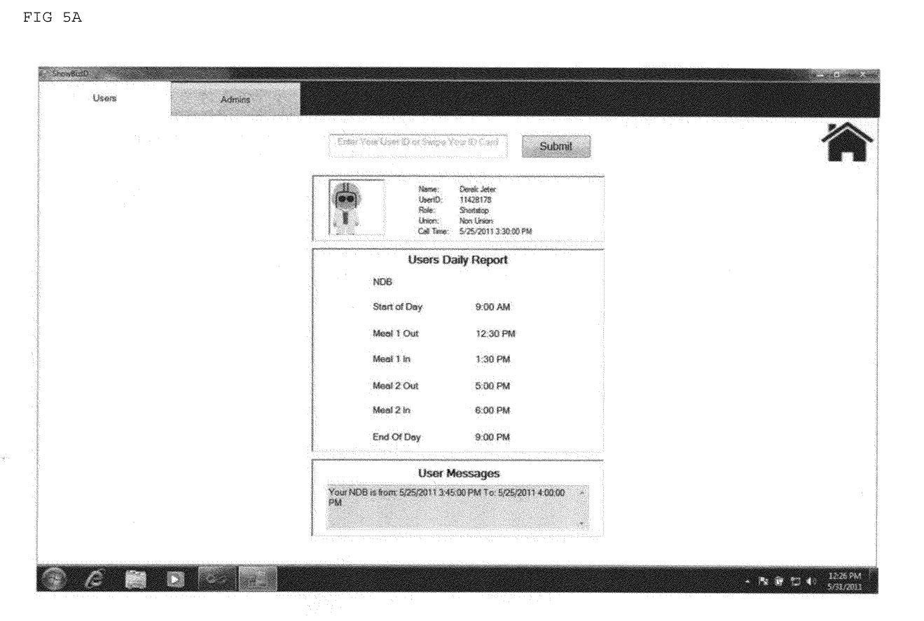

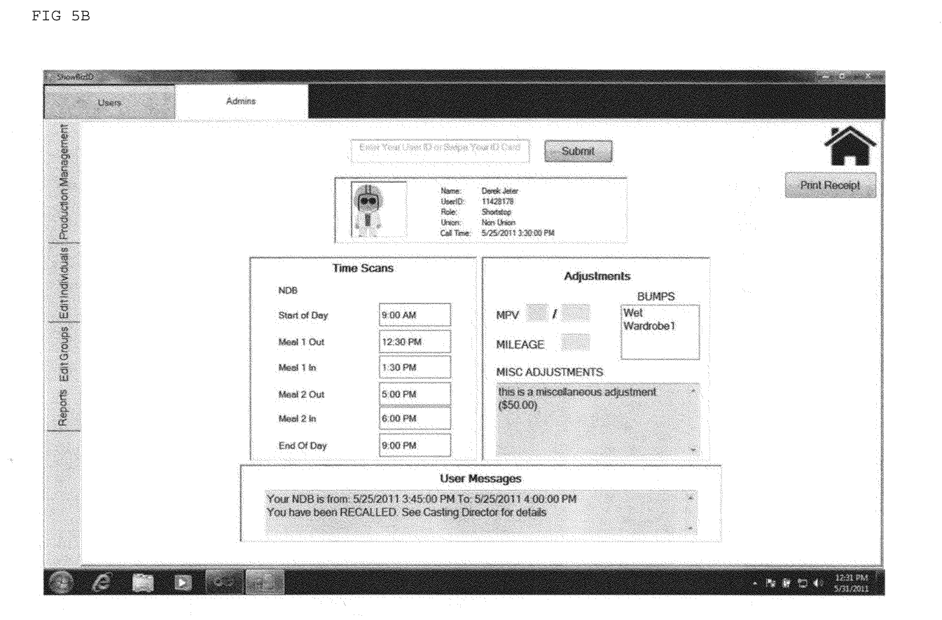

As actors and/or crew-members (users) arrive to check in for the work period, the administrator identifies each user in the production database via the GUI and other functionality of the Wizard and the Field Kit. User identification may be accomplished in several ways. For an existing user who has been pre-assigned a unique user ID, that unique user ID may be manually input via typing into a keypad 8 or into the touch-screen of the PC 3, or it may be identified based on personal information obtained when the user's identification card (i.e., drivers license, casting company ID card) is scanned using the card reader 4 or mobile scanning device 7 of the Kit 100, or it may be obtained when a bar code on a printed receipt is scanned using the card reader 4 or mobile scanning device 7 of the Kit. When the user is recognized, the Wizard displays production data for that user and one or more input fields on the PC 3 touch-screen. An example of a screen shot showing a user record and user data fields is depicted in FIG. 5A. A screen or record displaying this production data for a user may be called the “user daily report.” A user daily report showing additional fields for bonus adjustments is depicted in FIG. 5B. For checking in, the administrator taps a “check in” button on the GUI, and the time and event are recorded in the database. The entire sign in process for an existing user may be completed in ten seconds or less when data are entered manually and in less than 1 second from an ID card.

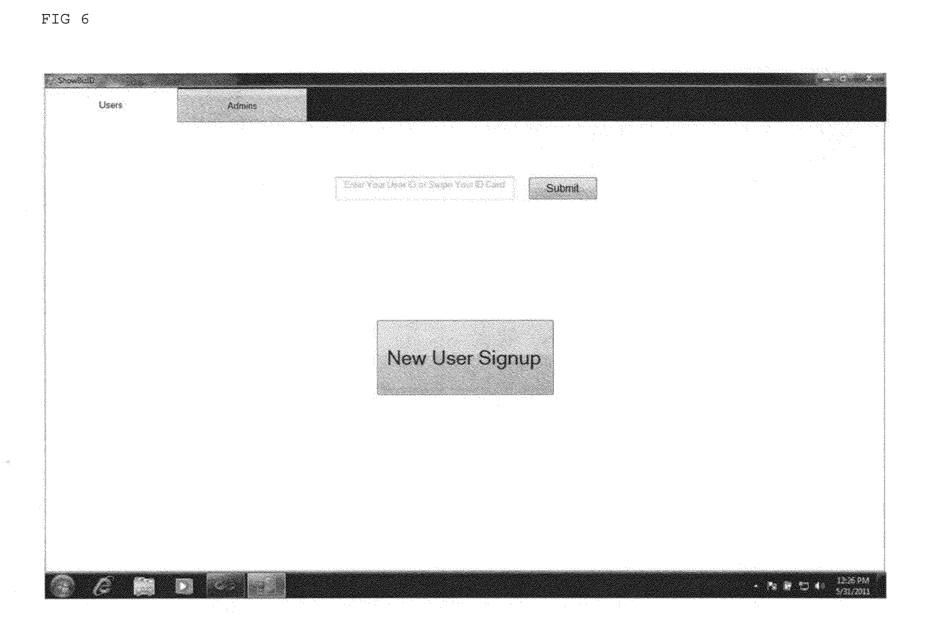

When a new user without a pre-assigned unique user ID checks in, the Wizard will create a new record in the database using the personal information obtained from the new user. The administrator may select this option from a menu command in the GUI as depicted in FIG. 6. Said personal information may be scanned into the Wizard via one of the scanning devices of the present invention using a drivers license or other ID, or it may be manually entered into a new user entry screen in the GUI. The Wizard will generate a valid unique User ID for the new user. If necessary, the Wizard will print a receipt, ID badge, or barcode via the thermal printer 5 of the Kit 100. These new users may be stand-ins sent at the last minute to replace a scripted actor, or they may be extras recruited to perform a bit part (“one-offs”). The Kit allows the rapid integration of new user data into the production database of the project.

In many situations, the administrator may prefer to perform the check in procedure or other event recording procedure at a distance from the Field Kit 100, which is accomplished using the mobile scanning device 7 of the Kit. In a preferred embodiment, the mobile scanning device 7 is an iPod comprising an application (Mobile ShowBizID Wizard) that is analogous to the Wizard running on the PC 3. The Mobile Wizard may synchronize with the PC 3 via a Wi-Fi device.

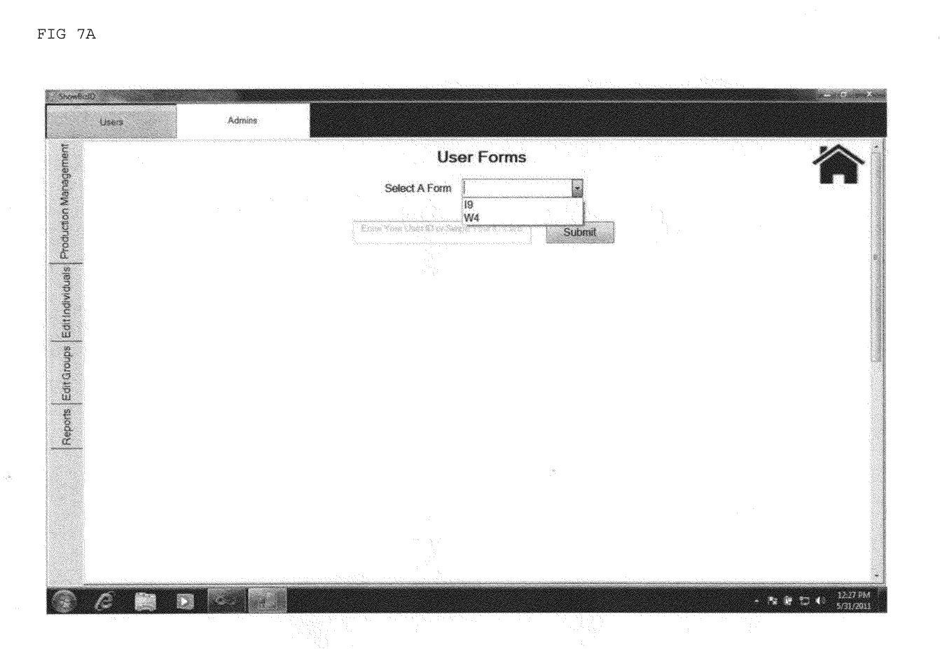

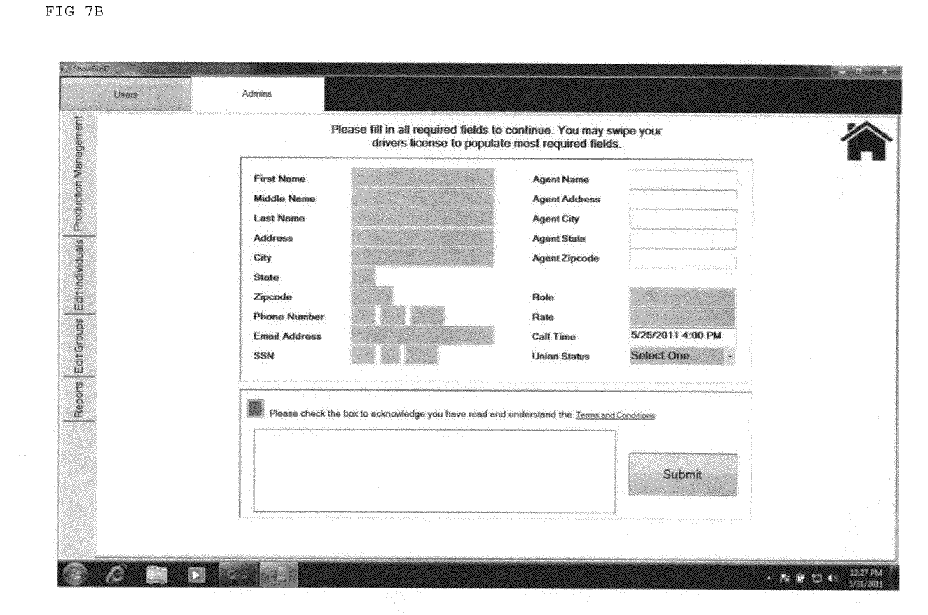

Often it will be necessary for personnel to fill out certain documents such as tax forms (e.g., I9, W4), waivers, releases (e.g., of photographs, for minors), non-disclosure agreements, and terms-of-service agreements. A menu screen for selecting specific forms to fill out is depicted in FIG. 7A. A user-specific terms-of-service agreement is shown in the screen shot depicted in FIG. 7B. These and other commonly used documents, as well as specific contracts known in advance to be needed on a particular project, may be previously installed in the memory of the system, such as on the PC 3, and may be completed as necessary or desired by the user or the administrator using the Kit. The Kit 100 and System 300 of the present invention thus substantially eliminate paperwork and minimize the time spent on routine administrative tasks.

Throughout the production day, the administrator may continue to update user data based on events and performance occurring as the production project unfolds. For example, the administrator may use the Mobile Wizard of the handheld device 7 to assign bonus event information to the user record of an actor who performs an unplanned task for which Union rules require an accounting. The Wizard of the Kit may also monitor expected events during the day and issue alerts to the administrator regarding the occurrence or of these events, such as break times, mandatory meal times, check-in and check-out times, and other events relevant to actor compensation and project execution. This monitoring and alerting is accomplished in part by software in the invention which references production data derived from the skins report and vouchers, and also in part by software in the invention which references a set of rules corresponding to the Union regulations or other guidelines that govern the actors and performances of the project. Relevant fields may be assigned to a user's account by the administrator through the GUI of the Wizard.

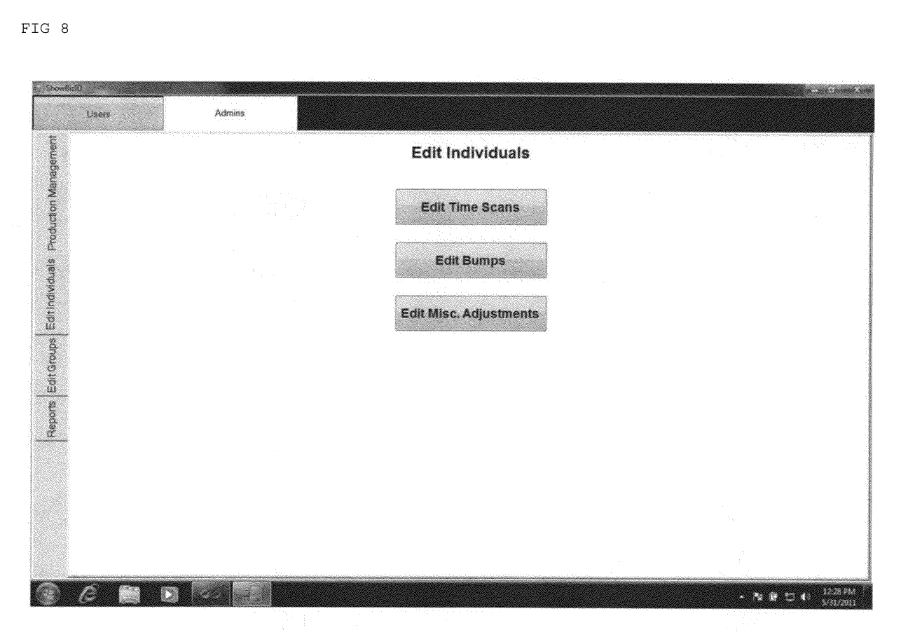

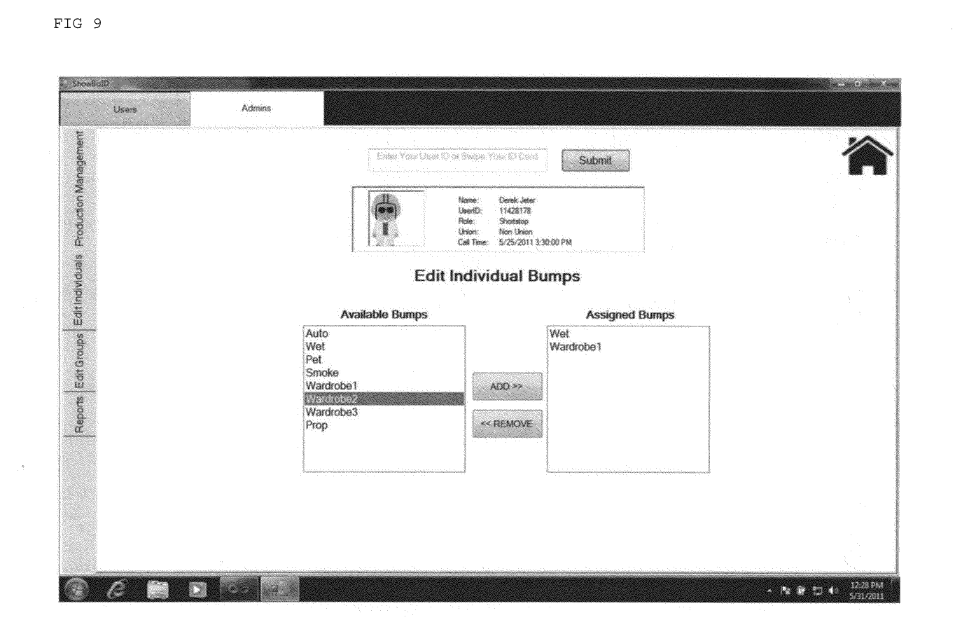

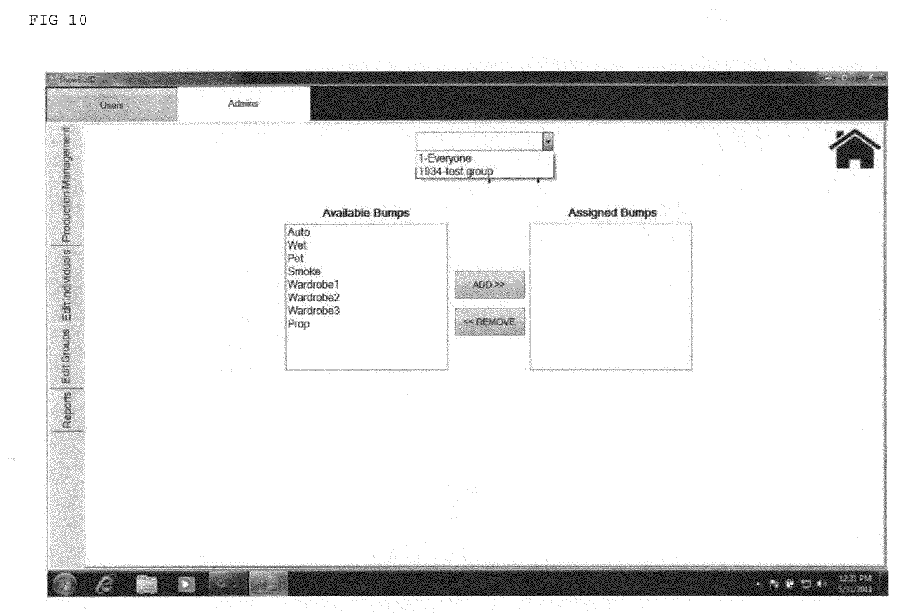

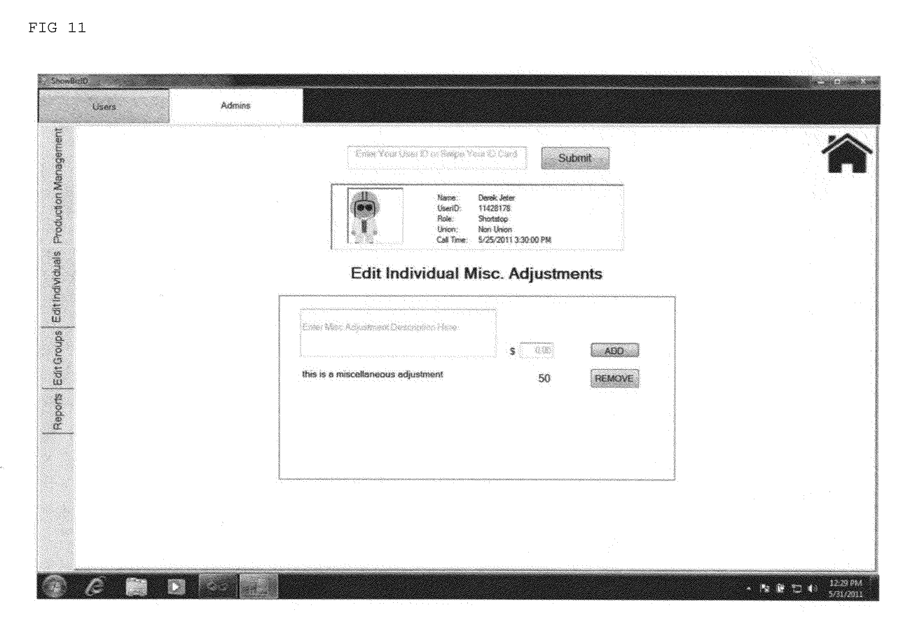

FIG. 8 depicts a screen for accessing the data in an individual user's record. FIG. 9 depicts a screen for assigning bonuses (“bumps” in industry jargon) that are available on a project to a user's record. FIG. 10 illustrates the dropdown feature for selecting the range of users to which a change in performance factors can be applied. FIG. 11 illustrates a screen shot of a feature that allows for adding unlisted or unconventional adjustment (miscellaneous adjustments) information to a user record.

During periods when a large number of users must be checked-in or checked-out of set, such as start time, mandatory meal times, break times, and end time, the invention rapidly processes event recording at the touch of a button on the screen of the PC 3 or the swipe of an identifying document such as an ID badge or printed receipt through one of the scanning devices such as 4 and 7. At these times, the Wizard of the Kit can perform automatic checks and cross-references to ensure that all conditions of the event are satisfied and it can issue alerts regarding any unfinished matters that need follow-up attention. For example, at check-out time, an actor checking out may be alerted that a wardrobe item needs to be returned or else a penalty will be incurred on that user's record. Similarly, during the rush to close the production day at check-out, and actor who has not reported to the administrator to check out may receive a text message or email alert from the Wizard, sent directly to the mobile phone or email account contained in the actor's user profile stored in the database of the Kit, informing the actor of the missed deadline. The Kit can alert the administrator or any other parties simultaneously or independently of such missed deadlines and tasks.

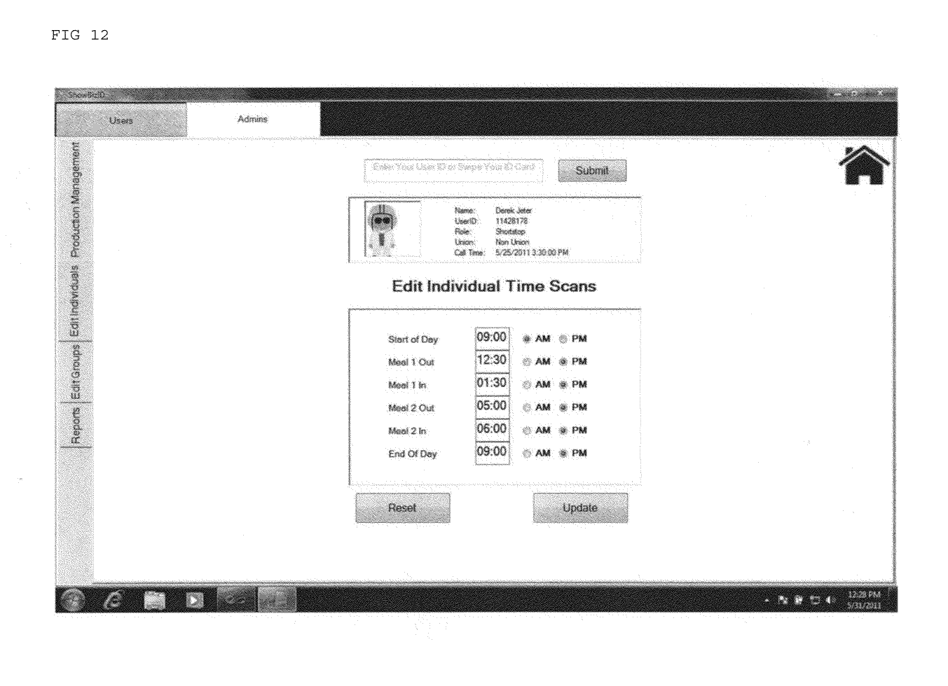

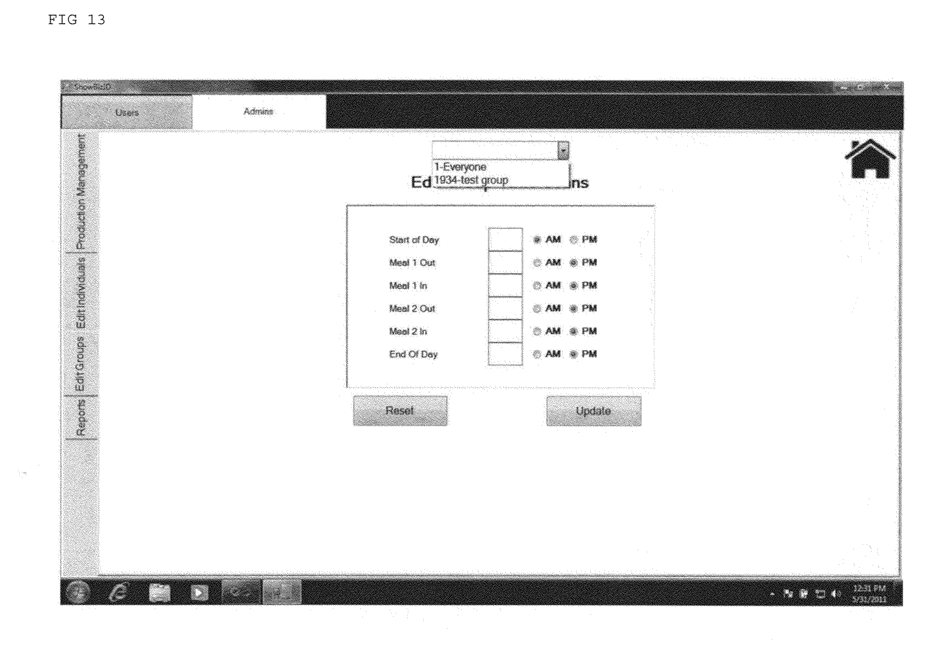

When human error occurs and an actor failed to report an event that was actually fulfilled, the administrator can edit the user record to belatedly enter the event. This can avoid false accruals of penalties. FIG. 12 shows a screen shot of a menu in the Wizard for editing time scans of an individual record. FIG. 13 illustrates how the range of individuals affected by the edit can be expanded using a dropdown menu. Digital signature can be applied to verify that the edits are authorized in real time, without the administrator having to submit amending paperwork to the casting and payroll companies later along with the breakdown report. This editability of the time scan function is another significant cost- and time-saving feature of the present invention.

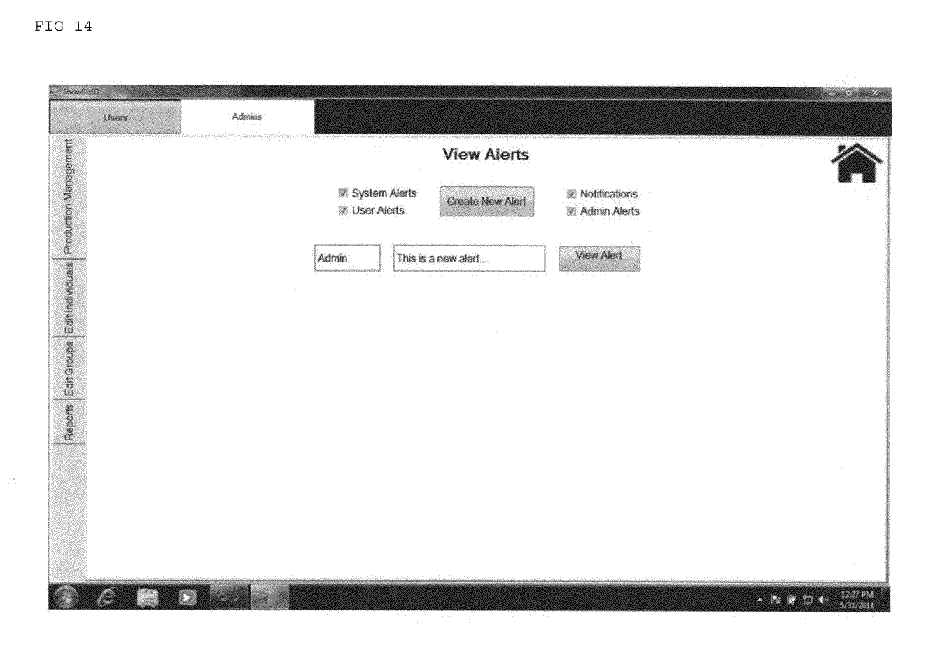

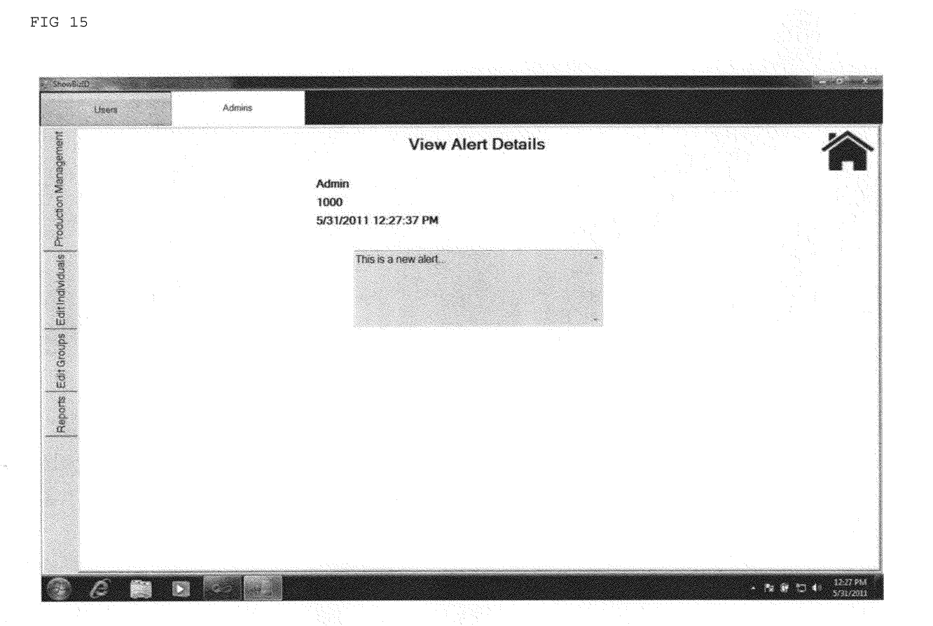

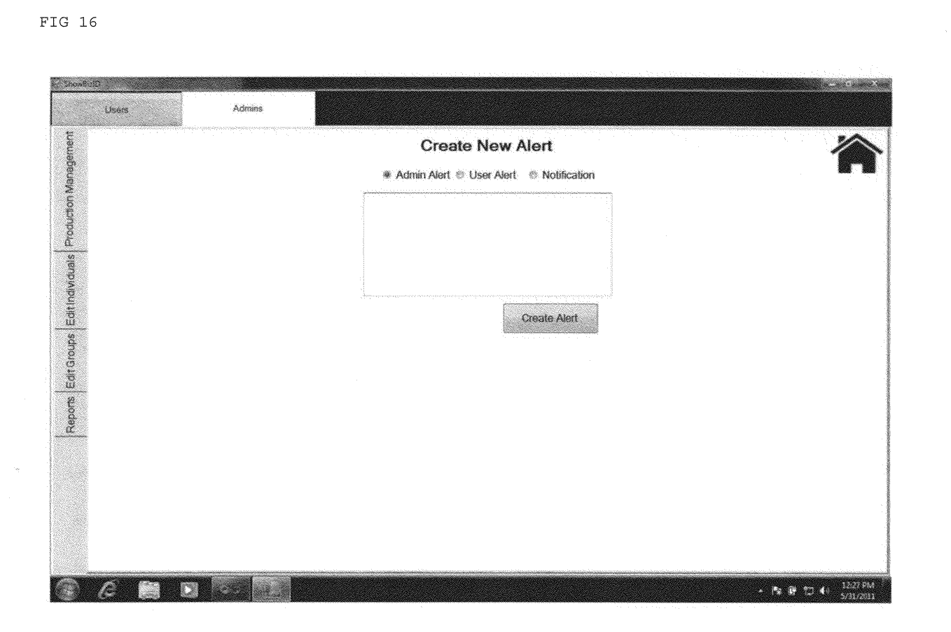

The programmed alert functions of the Kit 100 and System 300 are important ways in which the present invention increases the efficiency and lowers the cost of entertainment industry projects. FIG. 14 is a screen shot of a menu for controlling alerts in the Wizard. FIG. 15 shows a screen shot of a form that may be used to specify the features of a specific alert. FIG. 16 shows a screen shot of a form that may be used to create a new alert using the Wizard. Embodiments of the invention include various alerts to notify administrators, producers and casting directors, and other users via email, cellular phone text message, instant message, of any relevant issue. For example, alerts can comprise the issuance of a list of names that need to be contacted or checked-in/checked-out at an event time, alarms to notify the occurrence or impending occurrence of an event time, alarms to indicate the accrual of a penalty or bonus in real time, reminders for the administrator to inform certain actors of certain duties and rights that arise for them on a particular day or at a particular time, reminders to report to wardrobe or return props, notifications that additional work is required by the director before going home or on an ensuing day (recall notices). Also, these reminders, alarms, and alerts can be issued via any electronic means over any type of transmission. In instances when an actor is late or absent, the Wizard of the present invention may send alerts to the director, or to executives at the production company or casting company so that they can immediately begin attempting to locate the missing party or to recruit a replacement (no-show notifications). Furthermore, these reminders, alarms, and alerts can be recorded and time-stamped to create a record of proof that alerts were issued to the proper parties at the proper times and therefore they were given legally enforceable notice of their rights and obligations. And, these processes may occur without any direct action by the administrator.

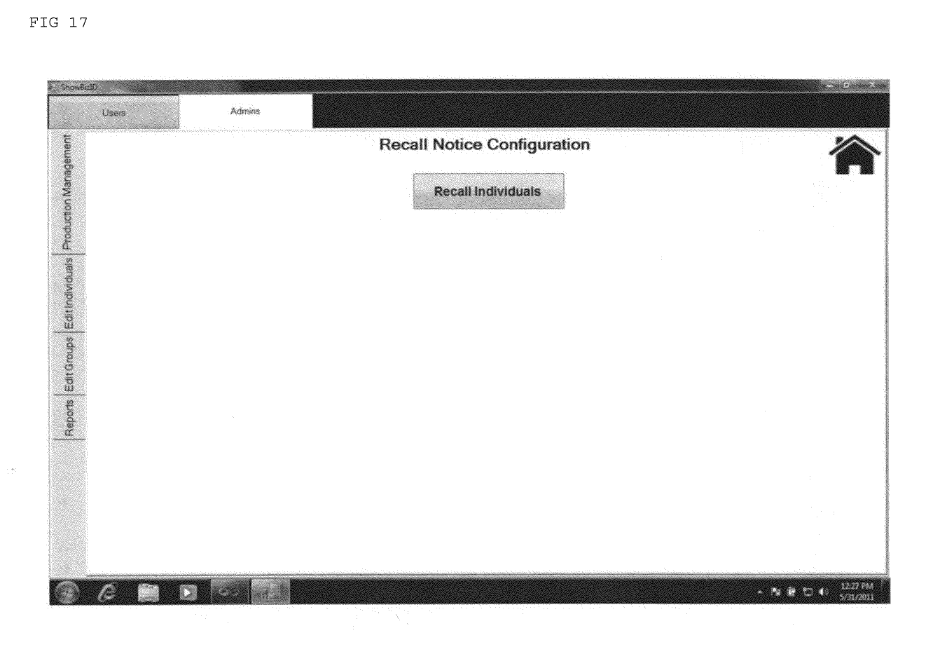

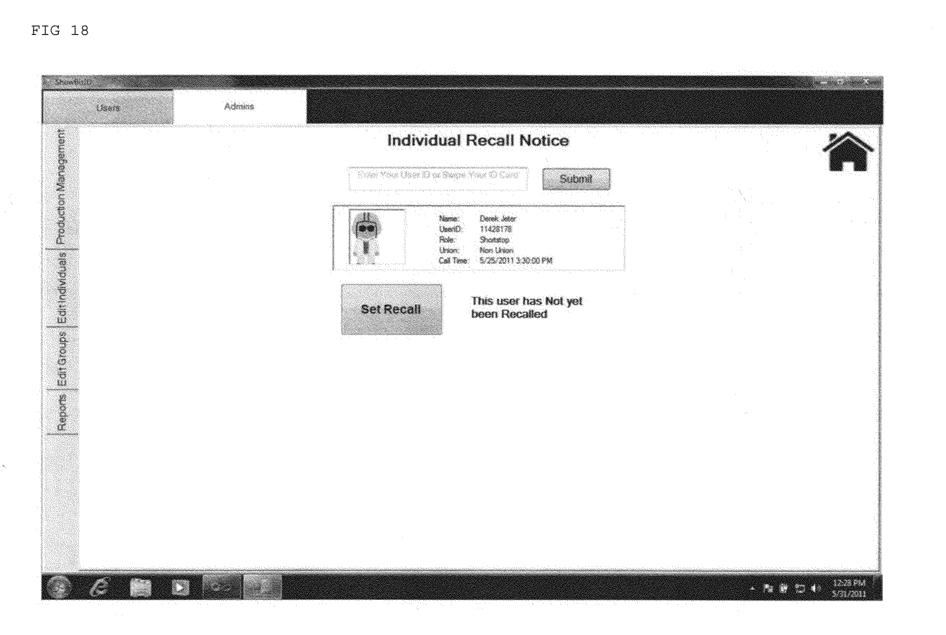

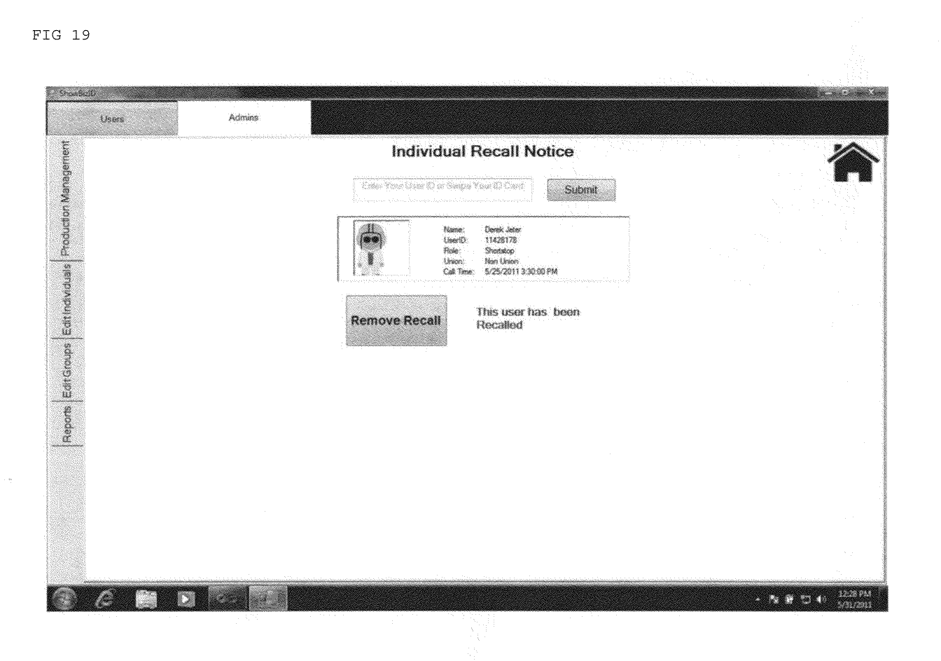

The invention also facilitates the execution of the production project itself. There are many instances when a director will decide an actor, or group of actors, needs to be recalled to re-shoot a scene, or to otherwise update an aspect of the performance. This requires locating and identifying the required actor(s) and informing them of the preparations they need to make and the location to which they must report at a particular time to complete the new task. FIG. 17 shows a screen shot containing a menu button in the GUI that can access the recall notice configuration application of the Wizard. FIG. 18 shows a screen in the GUI for creating an individual recall notice. FIG. 19 shows the change in message on the screen shot when the recall has been successfully applied.

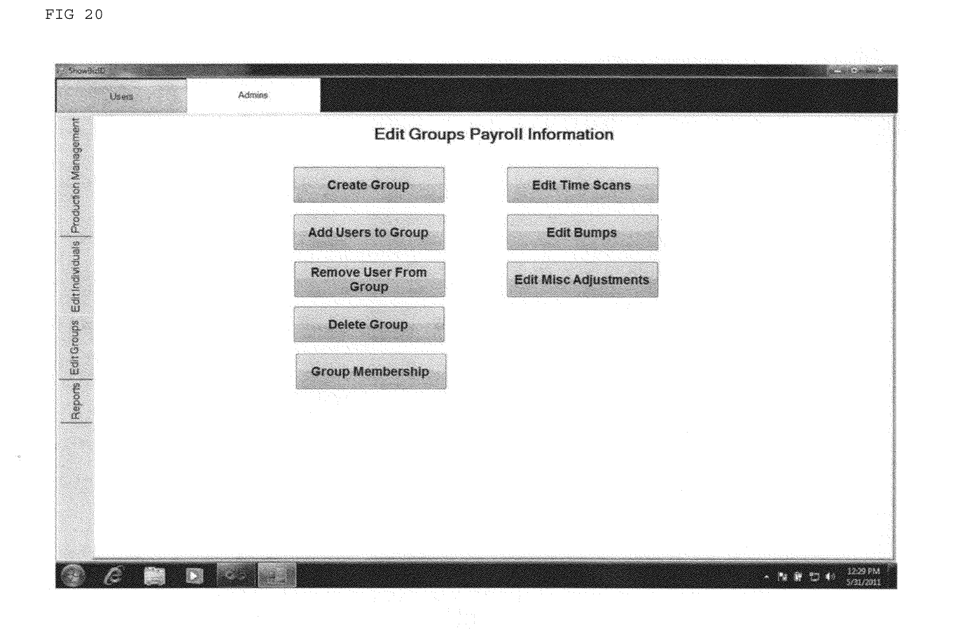

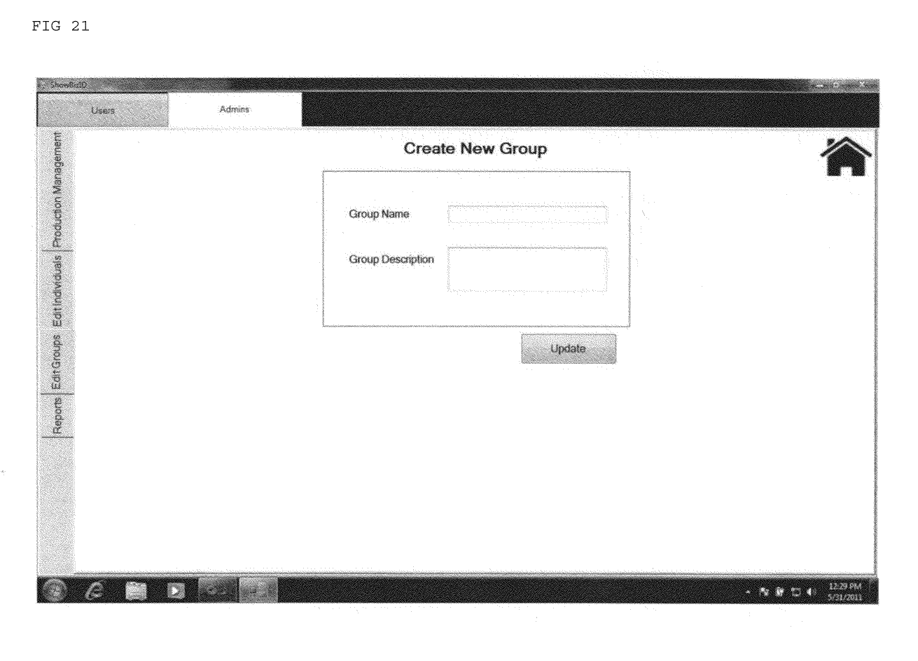

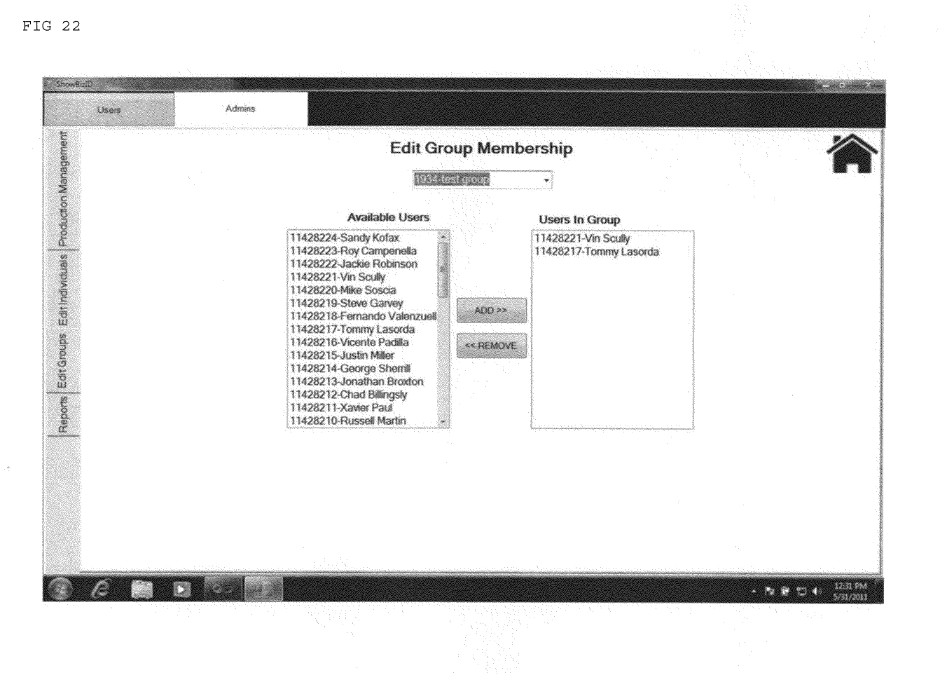

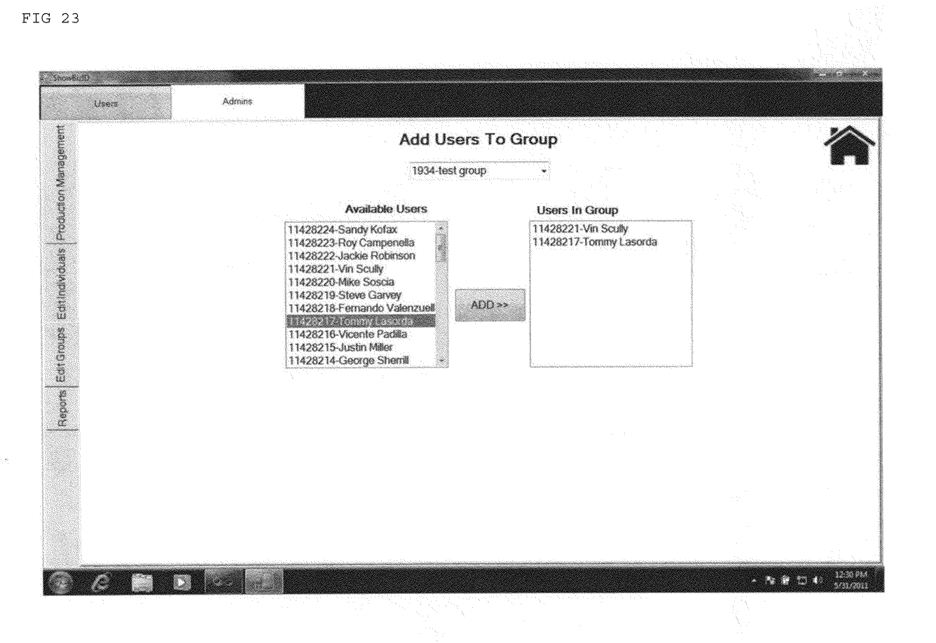

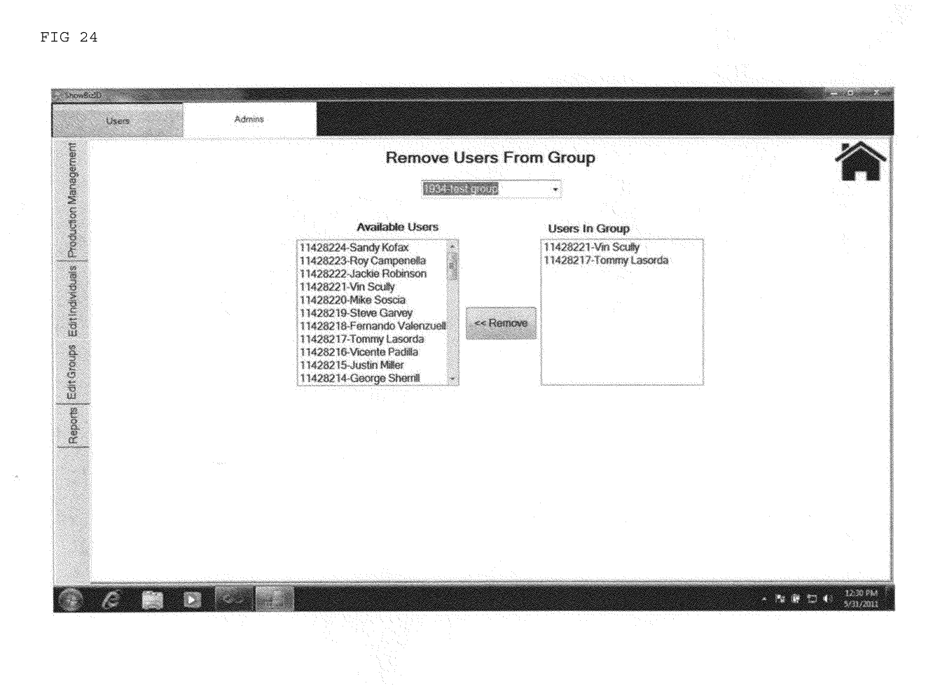

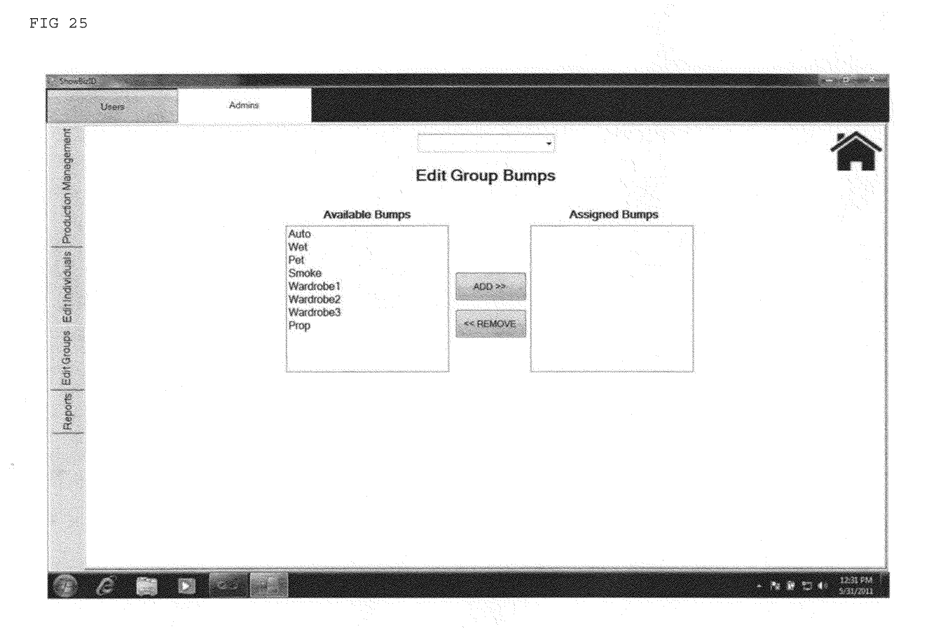

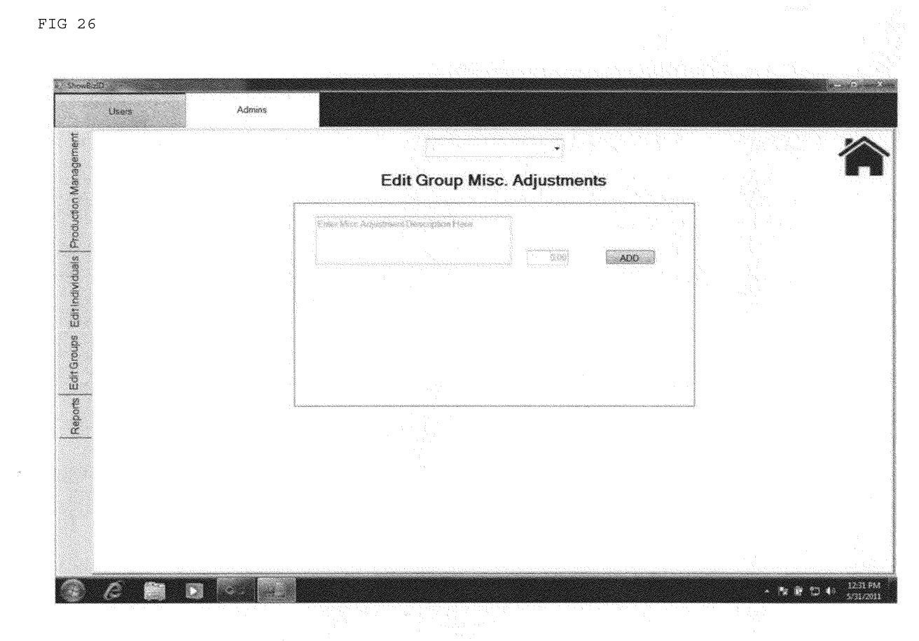

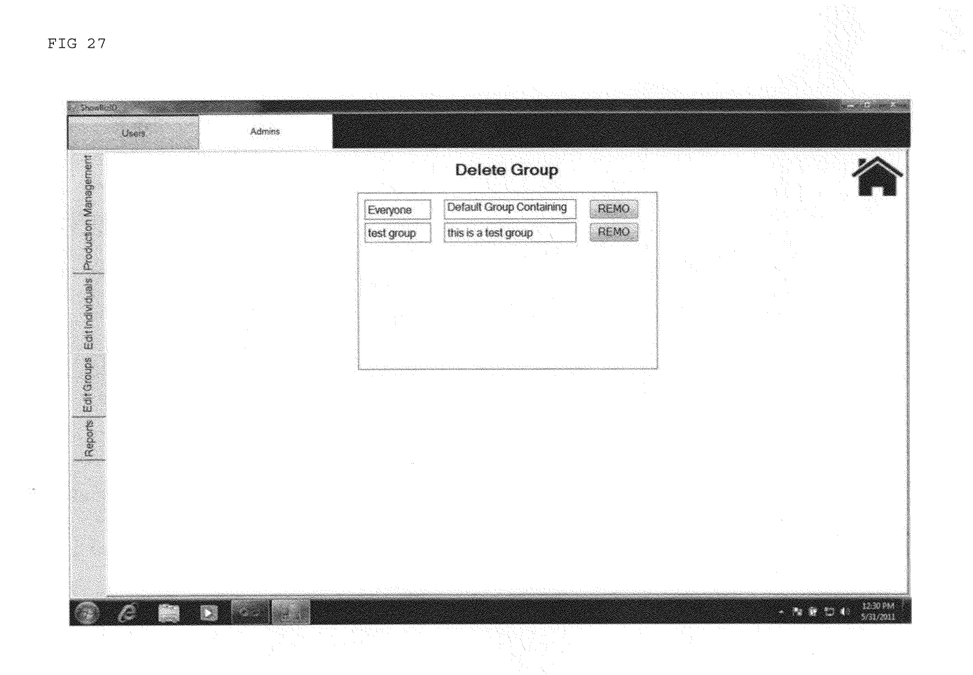

The Wizard can quickly create new groups and assign them to events, or create new events and assign them to groups by several means. FIG. 20 shows a menu screen in the GUI of the Wizard controlling various group options. FIG. 21 shows a screen shot of a form for creating a new group using the Wizard. FIG. 22 shows a screen for editing group membership. FIG. 23 shows a screen for adding users to a group and FIG. 24 shows a corresponding screen for removing users from a group. In one method, the administrator can manually input the data and link user records. Alternatively, the user can select one or more criteria and have the Wizard automatically identify all actors or events associated with said criteria. An instant update can be made to any other aspect of the software or database to finalize the incorporation of the new event/group into the production database, and alerts can be issued via the various alert and notification functions to rapidly identify and inform the people involved that changes have been made and that new directives apply. Bonuses can be assigned to groups as shown in the screen shot of FIG. 25 and miscellaneous adjustments can be applied to a group as shown in FIG. 26. Groups may also be selectively deleted through a menu like the one shown in FIG. 27.

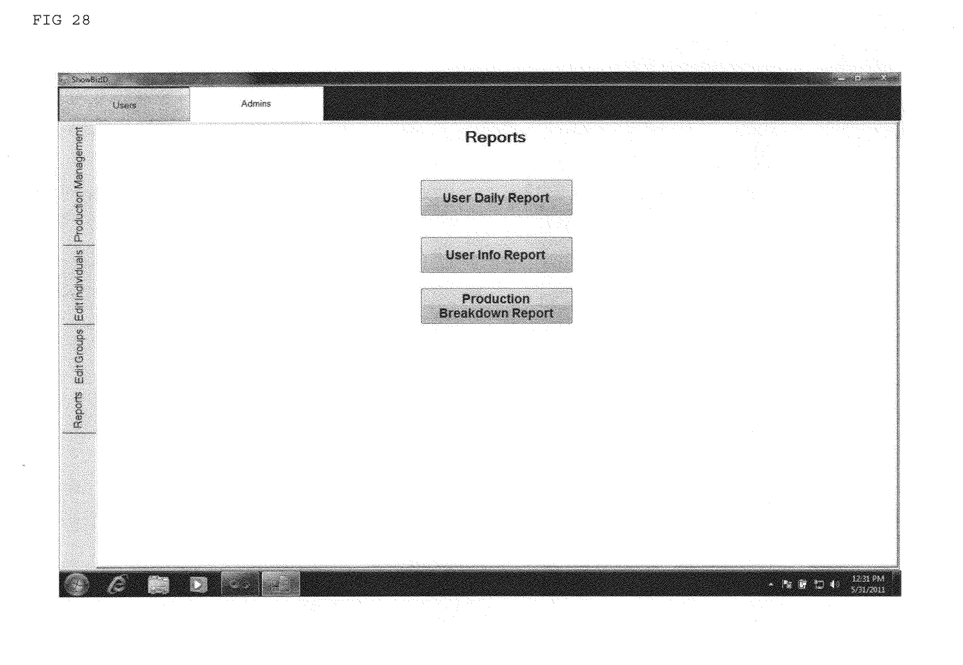

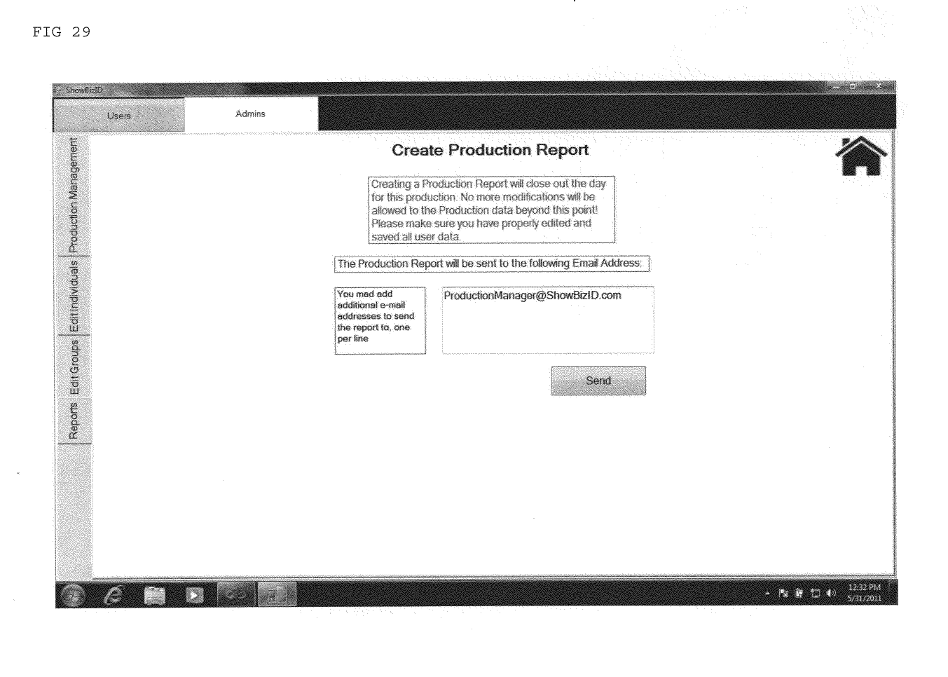

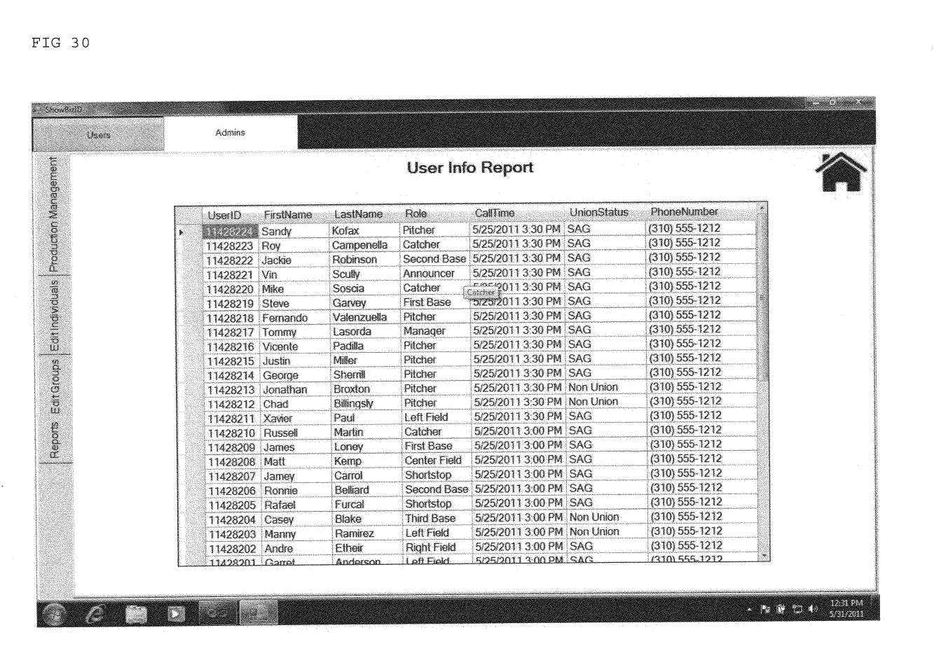

When actors are checking out at the end of the production day, the present invention may issue their e-Voucher via email sent directly to their preferred email address, by encoding it in a barcode printed on the thermal printer, or by printing it in a legible paper form mimicking the prior art layout of the paper receipt. It is possible with the system of the present invention to completely eliminate paperwork in the voucher-receipt process. As the production day is closed, after all data have been collected and the respective actor receipts have been generated, the entire collection of data corresponding to the production day exist in the memory of the Kit and may be stored in the database of the Kit. From there, it is a simple routine to transform them into a breakdown report that is finally sent back to the casting company or production company for review, payroll generation, or other downstream operations. Data collected during the production day, the result of penalty and bonus tabulations, and other miscellaneous additions can be automatically populated in receipts and breakdown reports by the software of the invention. FIG. 28 illustrates a GUI menu of the Wizard for selecting basic types of reports that may need to be generated. FIG. 29 shows a screen shot of an example of a control form for creating a Production Report. A screen shot from a sample of a user information report is illustrated in FIG. 30.

Whereas breakdown reports take a large amount of administrator time using prior art methods, the present invention can generate and optimize the breakdown report for production to other parties in seconds. A payroll company can download the data directly into their own proprietary databases. Software in the component devices of the Kit can convert production data into auto-filled forms, alternative databases, or custom reports as desired. Any form, report, or other output of the system can be time stamped and flattened to verify its authenticity and veracity. Actors can receive email copies of their vouchers and receipts, which by itself, is a major time- and labor-saving innovation, considering how frequently actors using the prior art methods have lost their paper vouchers and receipts or have presented complaints about perceived discrepancies between their vouchers/receipts and the payroll checks they ultimately receive. The system may also track inventory and expenses relevant to each user for materials consumed or utilized during their shifts. Ultimately, the invention can output various reports showing all of the data collected for the day.

### The ShowBizID e-Voucher System and Method

The ShowBizID e-Voucher system was designed to replace the existing antiquated, error-prone, and non-secure process of collecting time and attendance data for actors enrolled in a project, commonly termed “Background Actors Data.” Said existing process is performed with paper vouchers completed by hand and distributed via third party intermediaries or commercial courier services. The e-Voucher system improves the reliability and integrity of the data relied upon by casting companies, payroll companies, and production companies during the administration of an entertainment industry project. The e-Voucher system also automates the application of guild/union rules and provides alerts that help avoid violations which lead to unnecessary overages and penalties. Using the e-Voucher system, the process of recording an actor or crew member's time, attendance, and/or performance data is completed in seconds instead of the several minutes it may take using the antiquated manual procedure of said existing process. The e-Voucher system also permits the logging and tracking of all data entry actions for verification of their validity, veracity, and authorization.

The ShowBizID e-Voucher system is a distributed environment consisting of a central server 32 that acts as a repository for all data transmissions. It is the source that binds the casting company, production company, and payroll company processes into a cohesive workflow. At the core of a preferred embodiment is a Microsoft SQL server database where all data is eventually stored. Various web services running on a Microsoft IIS web server are employed to submit and retrieve data to and from this central database server 32. All communications take place over a secured network connection. Casting companies will upload “skins” data to the central server 32 for each production project to be monitored. These data are stored and made available to be downloaded at a later time by operation of the field kits 100 located on set. The ShowBizID e-Voucher system will operate in one or more field kits via the kit's PC 3 which runs a proprietary ShowBizID Application. Said Application is capable of providing all of the functions necessary to collect and process Background Actors time and attendance data.

Relevant data is stored on the tablet PC 3 in a local Microsoft SQL Server Express database. The Application interacts with this database to store and retrieve the Background Actors data. Actor time and attendance data can be collected by the ID card scanner devices 4 or 7 that are in communication with the PC 3. The handheld scanner device 7 is configured with a Mobile Application related to the Application on the PC 3. In a preferred embodiment, the Mobile Application is built specially for the Apple iPhone and iPod, where they may be used in conjunction with a magnetic strip/barcode reader. When the handheld scanner 7 is used within range of the ShowBizID Field Kit 100, said Mobile Application gives the production company the ability to remotely collect and monitor the identity and activity of Background Actors. When out of range, said data may be stored on the mobile scanning device 7 for later uploading to the PC 3 of the Kit 100 and/or the central server 32 of the System 300.

A wireless local area network (LAN) may be created via a Wi-Fi hotspot device to provide network connectivity between the Field Kit 100, which is a de facto base station, and handheld devices on the set. The LAN may also provide external access to the Internet, which allows connecting to the Central Server 32 and other remote sites.

The present invention allows each user to have a unique User ID. The user ID is either assigned ahead of time by the payroll company or in the case of a new user signing up on set, the system or software of the present invention will assign them a unique user ID. By using a unique user ID, the present invention enables a production team to safely track all of the users' data without exposing any personal information about them. On the backend, the users' unique ID numbers will be tied to their respective Tax ID numbers for payroll purposes. By not transmitting a user's personal information, the risk of identity theft is reduced dramatically compared to prior art methods. Once the user is in the system, his or her unique user ID is used to track activities on set throughout the day. An actor can clock in/out using the software application, and the administrator can assign to the actor any additional bonuses he or she is entitled to receive. Existing users have a unique user ID that may be typed into the program using the keyboard 8, input from the swiping of a drivers license or other magnetic stripe-bearing identification using the scanners 4 and/or 7, or input by reading a bar code or other means for conveying identification information on a physical object. New users (“one-offs,” “extras,” or those whose data were not pre-loaded into the system during the initial database population step) can be entered on-site in real-time by a combination of swiping an ID and manually typing the appropriate information into the appropriate fields of the Wizards GUI. The GUI contains instructions and entry forms for new user input.

The GUI contains, in addition to other features, virtual buttons for clocking in or clocking out using a touch screen. These buttons may be labeled “time-in” and “time-out” respectively. The Wizard may include a digital signature step and means for inputting a digital signature in the GUI. The user may input a digital signature to agree to terms of service or compensation or employment. Any and all of these functions programmed on the tablet PC 3 may have corresponding algorithms and functions on the handheld mobile device 7 of the Kit. This is important because in at least one embodiment the PC 3 runs on windows and the handheld 7 runs on Apple OS.

The handheld unit 7 in the kit has much of the same functionality programmed into it as does the tablet PC 3. The handheld device 7 synchronizes with the tablet PC 3 so that the database on the tablet PC 3 stores the most accurate and complete set of data. The iphone application was created to collect the data easily on set when away from the tablet base station. The software in the handheld devices 7 of the present invention has been specially adapted to rapidly collect data from users by scanning their User ID via Barcode or Magnetic stripe on a card or printed receipt. An administrator can also manually enter in the User ID to collect the information. In at least one embodiment, the software for use on and with the handheld scanner 7 is written in x-code for the iPhone.

The handheld scanner 7 may be used on site for real time monitoring of activity and bonuses during the shoot. An algorithm in one embodiment of the present invention rounds time data to the nearest 6 minutes. Alerts regarding bonuses, impending break times, and any other relevant data may be sent to the relevant individuals over any wireless communication means such as cell phone, email, Bluetooth, etc. These status updates, alerts and notifications may also be sent to the tablet PC 3 or the internet database on the central server 32 for recordation, storage, and processing. Alerts and notifications may include a list of users who need to be contacted in association with their contact information, notifications of timepoints, functions to prevent overtime penalties, reminders and informational notices about individual rights, duties, and breaks under their contracts, union membership rules, state and federal laws and regulations. The Kit and System of the present invention also preserve and communicate information regarding whether, when, about what, and to whom notifications shall be sent and/or have been sent. Various alerting mechanisms are built into the application software of the present invention to inform the necessary parties that an event has occurred or is about to occur.

For example, the following series of steps may occur in response to an impending meal penalty. An alert has been created by hardware and/or software in the present invention to notify the Assistant Director, and anyone else in the notification list, of the upcoming event. Notification times can be modified based on preferences defined for a project. The default times are pre-programmed as a series of alerts occurring at twenty minutes, then ten minutes, then one minute (20, 10, 1) prior to a determined break point. This alert will help assistant directors and production managers control their schedule, and it will avoid meal penalties assessed for failing to break for the meal on time. The alert is programmable to accommodate use of whatever rule set is defined by the production company or the governing Union rules.

As another example, the following steps may relate to a “no-show notification.” When actors do not arrive on set when expected, the hardware and/or software of the present invention can trigger an alert notification to be sent to the required parties. This list usually includes the production manager, the assistant director, and the casting director. This alert will enable a proactive approach to finding replacements for actors who do not show up on set as expected. The prior art need for the Assistant Director to call the casting director is eliminated. The alert of the present invention will send an email notification to a predetermined list of people and will allow the casting director to find a replacement faster than with the prior art process. The no-show notification can be triggered manually within the present invention, and is also configured to be sent after a user-defined amount of time. The calculation of the alert timing is based on the preconfigured time span during which the user may permissibly appear late and the predetermined call time of that user. So, if the system is configured to send the alert after a user is 15 minutes late, then the alert would be triggered at 9:15 for a user with a call time of 9:00 who has not shown up. This automated process expedites the process of replacing actors who do not show up.

The hardware and/or software of the present invention contains algorithms for reading, evaluating, and processing voucher data and storing it in databases. The PC 3 running Windows contains software that populates electronic documents, such as PDF's, with these data. These documents can substitute for the vouchers now used in the prior art. The present invention includes an algorithm for automatically generating an e-Voucher by auto-populating a PDF form with data from the user information stored in a database. The e-Voucher is digitally secured, which certifies its authorship, accuracy and/or official approval, and which prevents further unauthorized or undesired alteration of the document. One means for processing the PDFs involves flattening and stamping each PDF document. In at least one embodiment of the present invention, the form and function fields of the GUI are programmed in the C-sharp language.

Data, vouchers, and the various reports can also be emailed to the production company using an email address on file, or it can be downloaded at a later time from a secure website portal, or it can be copied to an external USB (Universal Serial Bus) device or other portable physical storage device to be taken with the administrator at the end of the day. The payroll company may also or alternatively download the raw daily user data directly to their own internal systems via secure web services. The payroll company could request the data and it would be sent to them electronically to be processed for importing into their own systems. At the end of a production day, the data stored in the present invention may be backed up and/or stored off-line, and then the Kit is returned to a condition in which it is ready to begin from the start of the process upon the next production day. Data from previous days is ideally not left in the Kit memory in case the kit is lost, stolen, or tampered with after-hours.

### Calculations

There are several calculations that are done within the software of the present invention in order to produce accurate time and attendance data for actors based on the Union rules being applied to the project. There are several unions in existence and each has their own set of rules regarding the actors' time on set, and these may vary according to geography and other factors.

### Non-Deductable Breakfast (NDB) and Non-Deductable Meal (NDM)

A union member that has a call time prior to the crew call time will be assigned a non-deductable breakfast break. The break time is defined as being 15 minutes prior to crew call time up to crew call time. The purpose of this non-deductible breakfast break is to bring the actors and crew up to the same start time so that they can all be broken for future breaks at the same times thus synchronizing daily procedures on set. The need comes from the union rules surrounding the number of hours actors and crew may work in succession without a break, and if those time limits are exceeded, what penalties should be assigned. By having the crew and cast all on the same schedule it is easy to break everyone at the same time and avoid penalties or having multiple groups on break at different times. A ShowBizID software application performs the necessary calculations based on the rule set defined and assigned to the production. It will determine if an actor is authorized for an NDB and will assign it if necessary to the actor and display it to them on the screen via the GUI.

The present invention provides an improvement over the prior art method. The prior art method entails the Assistant Director verbally telling the actor of the break. If the Assistant Director forgets to assign the user the NDB then penalties can accrue costing the production company unnecessary expense. The ShowBizID system alleviates the need to remember to verbally tell the actor of their NDB because it is displayed on the screen before them when they clock in for the day.

If an “extra” has a call time at any time in a 2 hour range before the official crew call, they receive an NDB which brings their official time, in time in terms of meal penalties, up to the crew call time, and typically the NDB is given 15 minutes before crew call. The period of NDB is generally assigned as the 15 minutes before crew call for this reason. For example, supposing an extra clocks in at 5:30 am but crew call is 7:00 am, the extra's NDB is officially set to span from 6:45-7:00 am. In terms of payment, the NDB does not affect the number of hours work. Payment would start in this example at 5:30 am. This means that the extra does not officially require a meal break until 1:00 pm when the crew breaks for lunch.

“Non-Deductible Meals (aka the NDM) might be breakfast, a midday or a midnight meal. The time period before the NDM must be announced and must be fifteen (15) minutes long. During this period, an actor should not be asked to do anything else such as go to make-up or be seen by wardrobe. It should be an uninterrupted meal period. The NDM resets the clock for an actor's next meal. If given properly, an NDM defers the next required meal break time to six hours from the conclusion of the NDM. A non-deductible meal is considered “on the clock” or billable time and it must be given within 2 hours of call time in order to be counted towards pay. Based on a user's call time and the crew call time the application will determine if an NDB condition is possible. If a user's call time is before crew call time then the user's call time and the current time during sign-in the application will determine if the user is to be given an NDB bonus or not. If the user is late for their call time and beyond crew call time then no bonus is given. If they are on time or late for their call, but are signing in before crew call time then the bonus is awarded. If the user's call time is before crew call time and the user is signing in before the crew call time then the NDB is given. The NDB is assigned as 15 minutes prior to crew call time up to crew call time.

### Meal Penalties

A meal penalty violation (MPV) is accrued when the actor has worked more than the allowed number of continuous hours without a break. This time limit is based on the rules set by the unions and is determined to occur based on the rule set defined for the production data. Currently the Assistant Director will at the end of the day determine the Meal Penalties for all of the users based on the data written on their vouchers. If a penalty is to be assigned, this will be indicated on the voucher form. The ShowBizID system will calculate if meal penalties are to be assigned based on the time scan data collected. At the end of the day the meal penalty calculation will be triggered by an event, and based on the rule set in use, the penalties will be calculated and assigned to the users if it is determined they are due. This calculation is derived from the rules defined by the unions. The system will use the collected data and the pre-defined rule set to perform the calculation and assign the bonuses if necessary.

Union rules state that extras must be broken for a sit down lunch six hours from the time that they are officially on the clock and six hours from the end of their last meal. Meal Penalties are assigned on the before-lunch and after-lunch basis. According to the typical actor's contract, the first meal should occur 6 hours from the original call time if the actor does not have an NDB. The production company is given a 12 minute grace period. The violations are set in half-hour increments. For example, if an actor's call time is 6:00 am, then the actor has a non-deductible breakfast from 6:45-7:00 am. This means the actor should be broken for lunch around 1:00 PM. In a hypothetical situation where said actor is still working at 1:30 PM and lunch is finally called at 2:00 PM, the production company has consequently incurred 2 meal period violations which are data to be entered on the actor's voucher. If the company had broken for lunch by 1:12 pm in this example, no meal period violations would have been incurred.

The Producer can deduct actual time up to one hour spent at meals. Meal penalty payments for violations of either meal period are: for the first half-hour, or fraction thereof $25; for the second half-hour $35, for each half-hour thereafter $50. The ShowBiz ID system will calculate based on the various time scans if a meal period penalty is due after all data have been collected and verified by the Production Administrator. The process will run and assign the penalties to the users if one or more are due, using the sign-in time of the user determine if an NDB was given. Logically, this can be expressed as: if not then use the sign in time, if yes then use the end of the NDB period time (this will be crew call time), from there determine the next time scan event. If it is a scan-in event, then throw an error because that is 2 scan-in events in a row. If the event is a scan-out even then determine the length of time between the scan in event and the scan-out event. If less than 6 hours then no penalty is awarded. If more than 6 hours then determine if a penalty is due and how many. Check to see if the scan in-time is within the 12 minute grace period. If it is then still no penalty is given. If the time is larger than 6 hours 12 minutes, then award meal penalties. Using the total time between scan-in and scan-out events determine the delta and subtract 6 hours; this will give the total penalty time. Using 30 minute increments or fractions thereof, determine the number of meal penalties to assign. Repeat this process for the next set of scan-in scan out events until all scans have been processed and all meal penalties assigned. There is usually one for the time between sign in and lunch out, and then again form lunch in and scan out. There could be more if the day is long but the system of the present invention will handle as much iteration as there are possibilities. The system of the present invention also uses variables for the different time allotments so that if the SAG or other unions change their rule sets surrounding the MPV process the application can handle those changes without a major revision. The logic will remain the same unless the rule structures change. Variations in time can be handled using the same logic and process as described here.

### Breakdown Reports

The logic for generating a breakdown report from user data collected during a production day are as follows, in at least one embodiment. All fields must match if records are to form a group. Step 1—separate Union from Non Union Actors. Step 2—separate into rates per hour e.g. 145/8 which is 145 dollars for 8 hours (all rates per hour must match). Step 3—separate groups of matching union status, and rate per hour, into matching call time. Step 4—separate the matching call time groups into matching lunchtime groups. Step 5—separate matching call time, lunchtime, and out time into groups. ALL FIELDS MUST MATCH. Step 6—separate the matching call time, lunchtime, and out-time groups in to groups based on adjustments and bonuses, meal penalties and NDB's. These are the total population of separate groups. The way the breakdown should be recorded is as follows: # of Stand In Actors first (always Union), # of Highest Rate Union to Lowest Rate Union second, # Within the respective rates, organize a list proceeding from the earliest call time to latest call time, with a space is left in between union and non union, then the same treatment is done with the non union numbers. Lastly, an overall breakdown of Union and Non Union Numbers for the Production Day is added to the breakdown with a grand total of how many extras were on set. Examples of breakdown data generating during this calculation are presented in Table 1.

TABLE 1

| # | rate | time in | lunch | time out | ndb | adj | mpv |
|---|---|---|---|---|---|---|---|
| 4 | 145/8 | 6AM | 12-1230pm | 845PM | | W | 0/1 |
| 2 | 136/8 | 530AM | 12-1230pm | 930PM | 545AM-6AM | W | 0/2 |
| 45 | 136/8 | 7AM | 12-1230pm | 9PM | | | 0/1 |
| 12 | 136/8 | 730AM | 2-230pm | 9PM | | S, | 2/0 |
| | | | | | | A | |
| | | | NON | | | | |
| | | | UNION | | | | |
| 20 | 64/8 | 530AM | 12-1230pm | 930PM | 545AM-6AM | | 0/1 |
| 7 | 64/8 | 530AM | 12-1230pm | 930PM | 545AM-6AM | A | 0/1 |
| 17 | 64/8 | 7AM | 12-1230pm | 845PM | | | 0/1 |

| | |
|---|---|
| Stand In | 4 |
| Union | 59 |
| Non Union | 44 |
| TOTAL | 107 |

It should be emphasized that the above described embodiments of the present invention exemplify some, but not all, possible implementations of the present invention and have been set forth in order to provide a clear understanding of its qualities. Those skilled in the art will appreciate that the conception upon which this disclosure is based may readily be utilized as a basis for designing of other structures, methods, and systems for carrying out the several purposes of the present invention. The following claims should be regarded as encompassing equivalent and various constructions insofar as they do not depart from the spirit and scope of the methods and devices consistent with the present invention.

I claim:

1. A system for managing assets and personnel in production projects of the entertainment industry, the system comprising:
a portable kit, the kit comprising a container measuring less than twelve cubic feet in volume having an interior space wherein
an interior partitioning means for securely holding a plurality of component devices is fixedly attached to said container,
wherein said plurality of component devices comprises at least one of each of
a computer having a touch-screen interface,
an electronic card reader,
a removable handheld device and a corresponding docking station therefor,
a printing means for generating printed output, and
a power strip mounted inside the container to supply power to said component devices,
wherein said container further comprises a flush mount power cord-connecting means for providing electrical connectivity between an external power source and the power strip, and
wherein said computer further comprises at least one wireless communication means, wherein said wireless communication means comprises a means for transferring data among any of the component devices, and
wherein said wireless communication means comprises a means for communicating with external electronic devices that are not part of the invention, and
wherein said computer further comprises at least one networking means for connecting any of the component devices to a network, and
wherein said network comprises at least one node in a remote location, and
wherein said network comprises at least one database application means for managing sets of data, and
wherein said computer comprises a graphical user interface means for enabling a human administrator to control the system, and
wherein any of said component devices comprises at least one software application for executing a plurality of administrative tasks related to an entertainment industry production project.

2. The system of claim 1 wherein said plurality of component devices further comprises a battery.

3. The system of claim 1 wherein said plurality of component devices further comprises a keyboard.

4. The system of claim 1 wherein said container further comprises a rugged weather-resistant casing and a fastenably closeable cover.

5. The system of claim 1 wherein the handheld device comprises an scanning means for inputting scanable data.

6. The system of claim 1 wherein the handheld device comprises a personal digital accessory.

7. The system of claim 6 wherein the personal digital accessory comprises an iPod.

8. The system of claim 1 wherein said administrative tasks comprise an integrated assortment of processes for fulfilling payroll-related personnel data management protocols representing at least one recognized standard practice in the entertainment industry.

9. The system of claim 1 wherein said administrative tasks comprise an integrated assortment of processes for managing an inventory of production assets according to at least one recognized standard practice in the entertainment industry.
